(19) United States
(12) Patent Application Publication
(10) Pub. No.: US 2026/0183902 A1
(43) Pub. Date: Jul. 2, 2026

(54) FIXED-ABRASIVE NANO-GRINDING PLATES, RELATED ARTICLES, AND RELATED METHODS

(71) Applicant: ENGIS CORPORATION, Wheeling, IL (US)

(72) Inventors: Clement N. Onyenemezu, Crest Hill, IL (US); Benjamin Reynolds Rosczyk, Evanston, IL (US); Hyeseung Rachel Bae, Lake Zurich, IL (US); Ion C. Benea, Prospect Heights, IL (US)

(21) Appl. No.: 19/129,350

(22) PCT Filed: Nov. 21, 2023
(86) PCT No.: PCT/US23/80661

§ 371 Date: May 13, 2025

Related U.S. Application Data
(60) Provisional application No. 63/427,531, filed on Nov. 23, 2022.
(60) Provisional application No. 63/458,253, filed on Apr. 10, 2023.

(51) Int. Cl. B24D 3/34; B24D 5/06; B24D 7/06; B24D 18/00

(52) U.S. Cl. CPC B24D 3/34; B24D 5/06; B24D 7/06; B24D 18/0009

(57) ABSTRACT

The disclosure relates to fixed-abrasive grinding plates, fixed-abrasive grinding tools formed therefrom, and related methods. The grinding plate generally has a composite structure with abrasive beads (e.g., beads with diamond abrasives), a porosity additive, and an inorganic filler and/or flux agent distributed throughout a binder matrix formed from a polymeric resin (e.g., a cured, thermoset resin) or a vitreous material (e.g., a fired, vitrified glass frit matrix).

### CROSS REFERENCE TO RELATED APPLICATION

Priority is claimed to U.S. Provisional Application No. 63/427,531 (filed Nov. 23, 2022) and U.S. Provisional Application No. 63/458,253 (filed Apr. 10, 2023), each of which is incorporated herein in its entirety.

### STATEMENT OF GOVERNMENT INTEREST

None.

### BACKGROUND OF THE DISCLOSURE

### Field of the Disclosure

The present disclosure relates to a fixed abrasive grinding plate and segments thereof suitable for use in precision grinding and polishing (in particular nano-grinding) of advanced materials, such as sapphire, titanium carbide reinforced alumina (AlTiC), silicon carbide (SiC), gallium nitride (GaN), aluminum nitride (AlN), zinc selenide (ZnSe), and other compound semiconductor materials, as well as glass, ceramic, metallic, and composite workpieces. The disclosed fixed abrasive grinding plate, which incorporates diamond beads or a mixture of abrasive particles and metal oxide beads, and fillers, bonded together with the aid of one or more binders and additives, delivers very smooth surfaces with low surface roughness for a wide range of workpiece materials, which can be coupled with relatively low material removal rates desirable in a nano-grinding process.

### Background

Industry practice of polishing AlTiC, SiC, GaN, AlN, ZnSe, as well as other similar materials, is by chemical-mechanical planarization (CMP) of the work piece on a pad or rigid plate. In the hard disk drive industry, the steps include rough lap and fine lap/polishing. The rough lap step uses the so-called free/fixed abrasive lapping method. The work piece is brought into contact with a turning plate and a conditioning ring for planarization, while dripping diamond slurry on the plate. The diamond grains embed into the metal turning plate (typically made from zinc, tin or tin-alloy) to form a 2-body system while others roll between the plate and the workpiece in a 3-body system. The use of free and fixed abrasive diamond delivers a higher material removal rate, but high surface roughness. The surface roughness is improved by adding another step of fixed abrasive lapping, where the work piece is brought into contact with a turning plate pre-embedded with diamond grains and lapped with a lubricant vehicle. The lubricant vehicle does not contain aggressive abrasives. The fixed abrasive lapping gives a lower lap rate and better surface finish. While the use of the free and fixed abrasive combination results in improvements in surface finish of the magnetic heads, there are still some disadvantages of handling free diamond slurries with respect to charging efficiency and uniformity. Only about 10% of the diamond in the dripped slurry is embedded into the plate with the rest dripping into the waste collection. Embedded diamond particles are pushed further into the plate as the lapping continues and a few of the diamonds may dislodge and scratch the workpiece. Each round of charged diamond has a limited life before recharging is necessary and very few of the diamond particles are actually charged into the plate.

Lapping and polishing may be performed using a diamond abrasive film, consisting of a flexible backing (i.e. PET, Mylar, etc.) coated with a layer of abrasive diamond and binder (i.e. nylon, polyester, epoxy resin, UV curable resin, etc.) which is mounted on a rigid substrate to act as a lapping plate. In U.S. Pat. Nos. 6,458,018; 6,634,929; and 6,722,952 diamond beads were incorporated into abrasive coatings suitable for abrading glass or ceramic work pieces. The abrasive article comprises a structured 3-dimensional coating on a flexible substrate. The structured fixed abrasive coating may be good for rough lapping but not for fine lapping where surface finish is important. The discrete 3-dimensional coating has sharp edges, which contribute to scratching of the work piece. Abrasive pads do not hold good flatness during extended lapping and are known to cause edge rounding of wafers. These abrasive films will need to be replaced frequently due to short run life.

In U.S. Pat. Nos. 8,628,383; 8,888,878; and 8,038,751 diamond beads and aggregates made from abrasive particles and nanoparticle binders were used to form coated abrasive products. In some instances, the abrasive aggregates were coated onto a flexible backing to form fixed abrasive pads, which have good stock removal and poor surface finish. When such pads are used to lap wafers, it is hard to maintain good flatness over a long time, and edge rounding will remain a problem. In other cases, the coated abrasive articles produced were tailored for grinding wheels and general-purpose grinding where surface finish is not important. Grinding wheels comes in different sizes, shapes and forms including standard wheel shape, cup wheel shape, mounted point shape, honing stone shape, etc. The type of binder used to hold the abrasive matrix together defines the type of grinding wheel. Ceramic bonded abrasive matrix are called vitrified bond wheels which represents majority of the grinding wheels, organic polymeric bonded wheels are called resin bond grinding wheels, while metal bonded wheels are metal bond grinding wheels. Vitrified bonded grinding wheels has been applied in precision nanogrinding of hard materials including SiC as demonstrated by Huo, Vacassy, and Amino. U.S. Pat. No. 6,394,888 teaches making resin bonded grinding wheel of high porosity and low abrasive content. The abrasive article was bonded directly to a rigid backing for easy attachment to the wheel base.

U.S. Pub. No. 2019/0255676 is directed to fixed abrasive three-dimensional plates for lapping and polishing, which generally require a harder composite/matrix material to achieve high material removal rates appropriate for lapping and polishing.

### SUMMARY

In one aspect, the disclosure relates to a resin fixed-abrasive grinding plate, such as a fixed-abrasive grinding plate (or segments thereof) comprising: a) a plurality of micron-sized composite abrasive beads (e.g., spherical or quasi-spherical abrasive beads) in an amount of 30 wt. % to 95 wt. % on a dry weight basis of the grinding plate; b) at least one porosity additive in an amount of 1 wt. % to 40 wt. % on a dry weight basis of the grinding plate; c) one or more inorganic fillers in an amount of 1 wt. % to 40 wt. % on a dry weight basis of the grinding plate; and d) at least one polymeric resin in an amount of 3 wt. % to 40 wt. % on a dry weight basis of the grinding plate, wherein the polymeric resin bonds the (spherical) abrasive beads (e.g., as well as the porosity additive and the inorganic filler(s) as distributed components in a composite structure with the polymeric resin as a binder matrix); wherein the grinding plate has a hardness value in a range of 20 to 120 on the Rockwell Hardness L scale. Optionally, the grinding plate also has a calculated density in a range 1.0 g/cm³ to 1.8 g/cm³. The grinding plate in this aspect can be free or substantially free from vitreous (or vitrified frit) matrix materials, for example containing only polymeric resin(s) as the bonding material for the grinding plate. The foregoing components and properties can similarly apply to segments of the grinding plate (e.g., segments or portions cut therefrom) incorporated into a grinding tool, such as a grinding wheel with a base plate and a plurality of grinding plate segments mounted or bonded thereto.

In one aspect, the disclosure relates to a vitrified fixed-abrasive grinding plate, such as a fixed-abrasive grinding plate (or segments thereof) comprising: a) a plurality of micron-sized composite abrasive beads (e.g., spherical or quasi-spherical abrasive beads) in an amount of 30 wt. % to 95 wt. % on a dry weight basis of the grinding plate; b) at least one porosity additive in an amount of 1 wt. % to 40 wt. % on a dry weight basis of the grinding plate; c) one or more flux agents in an amount of 1 wt. % to 40 wt. % on a dry weight basis of the grinding plate; and d) a vitreous matrix in an amount of 3 wt. % to 40 wt. % on a dry weight basis of the grinding plate, wherein the vitreous matrix bonds the (spherical) abrasive beads (e.g., as well as the porosity additive and the inorganic filler(s) as distributed components in a composite structure with the vitreous matrix as a binder matrix). Optionally, the grinding plate also has a calculated density in a range 0.7 g/cm³ to 1.3 g/cm³. The grinding plate in this aspect can be free or substantially free from polymeric resin matrix materials, for example containing only vitreous (or vitrified frit) materials as the matrix material for the grinding plate. The foregoing components and properties can similarly apply to segments of the grinding plate (e.g., segments or portions cut therefrom) incorporated into a grinding tool, such as a grinding wheel with a base plate and a plurality of grinding plate segments mounted or bonded thereto.

Various refinements of the disclosed fixed-abrasive grinding plate and segments thereof are possible, whether for the resin aspect, the vitrified aspect, or both aspects of the grinding plate.

In a refinement, the abrasive beads have an (average) particle size in a range of m to 50 μm or 5 μm to 40 μm; and/or each abrasive bead comprises (i) a plurality of abrasive particles having an (average) particle size in a range of 5 nm to 12 μm or 10 nm to m, and (ii) an inorganic metal oxide binder (e.g., as a coating or matrix containing the plurality of abrasive particles inside the composite abrasive bead). For example, the abrasive beads can have a size or average size of at least 5, 7, 10, 12, 15, 20, or 25 μm and/or up to 10, 15, 20, 25, 30, 35, 40, 45, or 50 μm. Alternatively, or additionally, the abrasive particles can have a size or average size of at least 0.005, 0.01, 0.02, 0.025, 0.035, 0.05, 0.1, 0.2, 0.5, 1, 1.5, 2, or 3 μm and/or up to 0.05, 0.1, 0.2, 0.5, 1, 1.5, 2, 2.5, 3, 4, 5, 6, 7, 8, 10, or 12 μm. The average sizes disclosed herein can represent weight-, volume-, or area-average sizes. Similarly, the size ranges disclosed herein can represent upper and lower bounds of a weight-, volume-, or area-based size distribution (e.g., 1%/99%, 2%/98%, 5%/95%, or 10%/90% cuts of a cumulative size distribution). Alternatively, or additionally, the sizes disclosed herein can represent minimum or maximum sizes in a particle size distribution, for example resulting from sieving, grading, or other size classification means.

In a further refinement, the abrasive particles are selected from the group consisting of natural diamond, synthetic diamond, cubic boron nitride, silicon carbide, and combinations thereof; the inorganic metal oxide binder is selected from the group consisting of silicon dioxide, titanium dioxide, cerium oxide, zirconium oxide, aluminum oxide, and mixtures thereof; and/or the abrasive particles are present in an amount of 20 wt. % to 90 wt. % of the abrasive beads (e.g., with the balance being the inorganic metal oxide binder). For example, the abrasive particles can be present in an amount of at least 20, 25, 30, 35, 40, 45, 50, 55, or 60 wt. % and/or up to 40, 45, 50, 55, 60, 65, 70, 80, or 90 wt. % relative to the abrasive beads. Alternatively, or additionally, the inorganic metal oxide binder can be present in an amount of at least 10, 20, 30, 40, 50, or 60 wt. % and/or up to 30, 40, 50, 60, 70, or 80 wt. % relative to the abrasive beads. In embodiments, the abrasive beads contain not more than 0.01, 0.1, or 1 wt. % of materials other than the abrasive particles and the inorganic metal oxide binder(s).

In a refinement of the resin grinding plate, a weight ratio of (i) the polymeric resin to (ii) the porosity additive in the grinding plate is in a range of 1 to 4; and/or a combined amount of the polymeric resin and the porosity additive in the grinding plate is at least 35 wt. % on a dry weight basis of the grinding plate.

In a refinement of the resin grinding plate, a weight ratio of (i) the polymeric resin to (ii) a combined amount of the porosity additive and the inorganic filler in the grinding plate is in a range of 0.8 to 1.5; and/or a combined amount of the polymeric resin, the porosity additive, and the inorganic filler in the grinding plate is at least 50 wt. % on a dry weight basis of the grinding plate.

In a refinement of the vitrified grinding plate, a weight ratio of (i) the vitreous matrix to (ii) the porosity additive in the grinding plate is in a range of 1 to 4; and a combined amount of the vitreous matrix and the porosity additive in the grinding plate is at least 30 wt. % on a dry weight basis of the grinding plate.

In a refinement of the vitrified grinding plate, a weight ratio of (i) the vitreous matrix to (ii) a combined amount of the porosity additive and the flux agent in the grinding plate is in a range of 0.8 to 1.5; and a combined amount of the vitreous matrix, the porosity additive, and the flux agent in the grinding plate is at least 40 wt. % on a dry weight basis of the grinding plate.

In a refinement, the grinding plate has a surface area porosity of 5% to 60% or 3% to 60%; and/or a plurality of the pores in the grinding plate is neither uniform nor regular and are not intra-connected throughout a thickness of the grinding plate. For example, the grinding plate can have a surface area porosity of at least 3, 5, 7, 10, 15, 20, 25, 30, or 40% and/or up to 10, 20, 30, 40, 50, or 60%.

In a refinement of the resin grinding plate, the polymeric resin is selected from the group consisting of benzoxazine resins, base-catalyzed phenolic resins, acid-catalyzed phenolic resins, epoxy resins, unsaturated polyester resins, and mixtures thereof. Benzoxazine resins are particularly suitable due to their superior hardness properties and very low water absorption characteristics. Benzoxazine resins can result from ring-opening crosslinking polymerization or copolymerization of unsubstituted or substituted benzoxazine monomers (e.g., 3-phenyl-2,4-dihydro-1,3-benzoxazine monomer as a representative phenyl-substituted benzoxazine monomer). In embodiments, the polymeric resin can include one or more benzoxazine resins in combination with one or more polymeric resins other than benzoxazine resins, for example phenolic resins, epoxy resins, etc. For example, the one or more benzoxazine resins can be present in an amount of at least 20, 25, 30, 35, 40, 45, 50, 55, 60, 65, or 70 wt. % and/or up to 40, 45, 50, 55, 60, 65, 70, 80, 90, or 95 wt. % relative to total polymeric resin. Similarly, the one or more polymeric resins other than benzoxazine resins can be present in an amount of at least 5, 15, 25, 35, 45, 55, or 65 wt. % and/or up to 30, 40, 50, 60, 70, or 80 wt. % relative to total polymeric resin.

In a refinement of the vitrified grinding plate, the vitreous matrix comprises silica (SiO₂) and one or more of lithium oxide (LiO), sodium oxide (Na₂O), potassium oxide (K₂O), boron trioxide (B₂O₃), aluminum oxide (Al₂O₃), calcium oxide (CaO), magnesium oxide (MgO), barium oxide (BaO), zirconium oxide (ZrO), zirconium dioxide (ZrO₂), titanium dioxide (TiO₂), zinc oxide (ZnO), calcium difluoride (CaF₂), manganese dioxide (MnO₂), and bismuth trioxide (Bi₂O₃). For example, silica can be present in the vitreous matrix in an amount of at least 20 wt. %; one or more of sodium oxide, potassium oxide, aluminum oxide, calcium oxide, and barium oxide can be individually present in the vitreous matrix in an amount in a range of 3 wt. % to 30 wt. %; and optionally, boron trioxide can be present in the vitreous matrix in an amount of at least 3 wt. %. The foregoing oxides and relative amounts can similarly apply to a glass frit powder used to form the vitreous matrix.

In a refinement of the vitrified grinding plate, the vitreous matrix and/or its corresponding glass frit material can be characterized according to one or more of its linear coefficient of thermal expansion, transformation temperature, and softening temperature. In an embodiment, the vitreous matrix or its glass frit material can have a linear coefficient of thermal expansion in a range of 20×10⁻⁷/K to 200×10⁻⁷/K (or 50-100×10⁻⁷/K; evaluated over 20-400° C.). In an embodiment, the vitreous matrix or its glass frit material can have a transformation temperature in a range of 400° C. to 800° C. (or 400-600° C.). In an embodiment, the vitreous matrix or its glass frit material can have a softening temperature in a range of 500° C. to 1000° C. (or 500-700° C.).

In a refinement, the porosity additive comprises hollow glass spheres having an average diameter in a range of 10 μm to 200 μm or 1 μm to 500 μm. More generally, the hollow glass spheres or other porosity additive can have a size or average size of at least 1, 2, 5, 10, 15, 20, 30, 40, 60, 80, or 100 μm and/or up to 10, 20, 30, 40, 50, 70, 100, 150, 200, 300, 400, or 500 μm. As noted above, the foregoing sizes can represent weight-, volume-, or area-based average sizes or size distributions, maximum or minimum sizes, etc.

In a refinement, the inorganic filler is selected from the group consisting of calcium carbonate, calcium metasilicate, talc, kaolin, calcium oxide, and mixtures thereof.

In a refinement, the flux agent is selected from the group consisting of clay, kaolin, feldspar (an aluminum tectosilicate), borax (a hydrated or anhydrous borate of sodium), talc, wollastonite (calcium metasilicate), nitrates of lithium, sodium, and potassium, carbonates of lithium, sodium, and potassium, and combinations thereof.

In a refinement, the grinding plate further comprises at least one oxidizing agent such as a permanganate, a periodate, an iodate, a chlorate, ammonium cerium nitrate, and/or a persulfate, for example including a potassium salt, an alkali metal salt, or other salt thereof. More generally, the grinding plate can include one or more chemical agents or oxidizers that react with the work piece during machining to improve material removal and/or surface finish. Such chemical agents or oxidizers, whether potassium permanganate, potassium periodate, or otherwise, can be included in the grinding plate in an amount of 0.1 wt. % to 5 wt. % on a dry weight basis of the grinding plate, for example at least 0.1, 0.2, 0.5, 1, 1.5, or 2 wt. % and/or up to 1, 2, 3, 4, or 5 wt. %.

In another aspect, the disclosure relates to a fixed-abrasive grinding tool comprising: a base plate (e.g., steel or other support substrate adapted to be rotated in a grinding or polishing process using the tool); and a plurality of fixed-abrasive grinding segments mounted to the base plate (e.g., as separate, individual grinding elements on the base plate). The fixed-abrasive grinding segments comprise the fixed-abrasive grinding plate according to any of the variously disclosed refinements, embodiments, etc. or a portion thereof (e.g., portions cut from a base grinding plate to provide the segments), for example including the resin grinding plates or the vitrified grinding plates.

In a refinement, the fixed-abrasive grinding tool is in the form of a grinding wheel, for example a cup wheel. In contrast to a unitary lapping plate structure, a grinding wheel tool typically includes a plurality of separate, distinct grinding (or nano-grinding) elements. Grinding wheels are available in wide range of shapes (generally called “types”), which are typically accepted standards from ANSI B74.2. For most applications, the correct wheel shape can be selected from these standard configurations. Examples of representative grinding wheel shapes/configurations include straight, cylinder, recessed 1 side, recessed 2 sides, saucer, straight cup, flaring cup, dish, cone, square plug, round plug, relieved 1 side, relieved 2 sides, relieved 1 side and recessed other side, relieved and recessed 1 side, relieved 1 side and recessed 2 sides, relieved 2 sides and recessed 1 side, relieved and recessed 2 sides, raised hub disc wheel, and raised hub dish wheel.

In another aspect, the disclosure relates to a fixed-abrasive grinding kit comprising: a plurality of fixed-abrasive grinding tools according to the disclosure, wherein (i) at least one fixed-abrasive grinding tool comprises the at least one polymeric resin, and (ii) at least one fixed-abrasive grinding tool comprises the vitreous matrix. A combination of two different grinding tools can be used in succession when machining a substrate: A vitrified grinding plate according to the disclosure can be used in a first machining step, because it generally provides a relatively high material removal rate, but a relatively coarser surface finish or roughness. A resin grinding plate according to the disclosure can be used in a second machining step, because it generally provides a relatively lower material removal rate, but a relatively finer/smoother surface finish with lower roughness.

In another aspect, the disclosure relates to a method for machining a substrate, the method comprising: performing at least one of grinding and polishing with the fixed-abrasive grinding tool according to any of the disclosed refinements, embodiments, etc. on a substrate. In embodiments, the method comprises performing nano-grinding as a grinding operation on the substrate. In general, a grinding step can be a high stock removal step with large diamond sizes, while a nano-grinding typically uses an abrasive with submicron abrasive particles to achieve a good surface finish with little or no material removal. Nano-grinding as an operation can achieve the performance of a polishing operation (e.g., in terms of low surface roughness), but it is generally regarded as distinct from a polishing method.

In a refinement, in particular when using a resin grinding plate, the substrate has an initial surface roughness Ra of at least 30 nm or at least 10 nm prior to performing the at least one of grinding and polishing; the substrate has a final surface roughness Ra of not more than 1 nm subsequent to performing the at least one of grinding and polishing; and/or an average material removal rate from the substrate is not more than 1 μm/min while performing the at least one of grinding and polishing (e.g., between initial and final states of the substrate). The surface roughness Ra can represent an average, arithmetic mean of profile height deviations from the mean line of a surface. In some embodiments, the substrate has a final roughness parameter Rt of not more than 30 nm or not more than 20 nm subsequent to performing the at least one of grinding and polishing. The roughness parameter Rt is the vertical distance between the highest peak and lowest peak of a surface roughness profile within the overall measuring distance (i.e., maximum peak to valley height). In other words, this is the height difference between the highest mountain and lowest valley within the measured range. In some embodiments, the substrate has a final roughness parameter Rv between 0 nm and −25 nm or between 0 nm and −10 nm subsequent to performing the at least one of grinding and polishing. The roughness parameter Rv is the average valley depth over the measurement surfaces. Surface roughness parameters can be measured using any suitable apparatus known in the art for such purpose, for example using an optical surface interrogation device such as a Zygo NEWVIEW 6k Optical Profilometer (available from Zygo Corporation, Middlefield, CT).

In a refinement, in particular when using a vitrified grinding plate, the substrate has an initial surface roughness Ra of at least 100 nm, 200 nm, or 300 nm prior to performing the at least one of grinding and polishing; the substrate has a final surface roughness Ra of not more than 5 nm subsequent to performing the at least one of grinding and polishing; and an average material removal rate from the substrate is in a range of 2 μm/min to 10 μm/min while performing the at least one of grinding and polishing.

In a refinement, the method comprises performing at least one of grinding and polishing on the substrate with a first fixed-abrasive grinding tool comprising the vitreous matrix; and subsequently performing at least one of grinding and polishing on the substrate with a second fixed-abrasive grinding tool comprising the at least one polymeric resin. As described above, a serial machining operation including a first quick/coarse initial step with a vitrified tool and a second slower/fine subsequent step with a resin tool can provide an overall faster process (due to the high removal rate with the vitrified tool) while still obtaining a sufficiently smooth final surface (due to the low resulting surface roughness with the resin tool). Typically, the same type of tool is used in both steps (e.g., a vitrified cup wheel and a resin cup wheel in succession), although different tool types can be used in the two steps in some embodiments.

In a refinement, the substrate is selected from the group consisting of sapphire, titanium carbide reinforced alumina (AlTiC), silicon carbide (SiC; e.g., (α)3C-SiC, 4H-SiC, (β)6H-SiC), gallium nitride (GaN), aluminum nitride (AlN), zinc selenide (ZnSe), silicon wafers (e.g., semiconducting silicon, such as crystalline silicon), ceramic substrates, optical substrates (e.g., transparent glass or polymeric materials), and combinations thereof.

In another aspect, the disclosure relates a method for forming (resin) fixed-abrasive grinding segments, the method comprising: performing at least one of hot-pressing, heat-assisted hardening, and room-temperature hardening of a mixture to form a blank plate, the mixture comprising: a) a plurality of micron-sized composite (spherical) abrasive beads in an amount of 30 wt. % to 95 wt. % relative to the mixture, b) at least one porosity additive in an amount of 1 wt. % to 40 wt. % relative to the mixture, c) one or more inorganic fillers in an amount of 1 wt. % to 40 wt. % relative to the mixture; and d) at least one uncured polymeric resin in an amount of 3 wt. % to 40 wt. % relative to the mixture; and cutting the blank plate to form a plurality of fixed-abrasive grinding segments each comprising the resin fixed-abrasive grinding plate according to any of the disclosed refinements, embodiments, etc. (e.g., having the components and properties of the fixed-abrasive grinding plate above). The mixture that is hot-pressed can further include other desired additives or components of the eventual grinding segments, for example a chemical agent or oxidizer, etc.

In another aspect, the disclosure relates a method for forming (vitrified) fixed-abrasive grinding segments, the method comprising: performing firing of a mixture to form a blank plate, the mixture comprising: a) a plurality of micron-sized composite (spherical) abrasive beads in an amount of 30 wt. % to 95 wt. % relative to the mixture, b) at least one porosity additive in an amount of 1 wt. % to 40 wt. % relative to the mixture, c) one or more flux agents in an amount of 1 wt. % to 40 wt. % relative to the mixture; d) a plurality of glass frits in an amount of 3 wt. % to 40 wt. % relative to the mixture; e) optionally a binder (e.g., a gum) in an amount up to 5 wt. % relative to the mixture; and cutting the blank plate to form a plurality of fixed-abrasive grinding segments each comprising the vitrified fixed-abrasive grinding plate according to any of the disclosed refinements, embodiments, etc. (e.g., having the components and properties of the fixed-abrasive grinding plate above).

In a refinement, the plurality of fixed-abrasive grinding segments are cut from an interior portion of the blank plate (e.g., and further excluding any grinding segments from an exterior/peripheral/edge portion of the blank plate).

In a further refinement, the interior portion corresponds to an interior surface area in a range of 50% to 80% or 40% to 90% (e.g., at least 40, 50, 60, or 70% and/or up to 60, 70, 80, or 90%) relative to a surface area of a face of the blank plate. For example, an outer 20% to 50% or 10% to 60% (e.g., at least 10, 20, 30, or 40% and/or up to 30, 40, 50, or 60%) of exterior/peripheral/edge surface area of the blank plate face is not cut into grinding elements or otherwise incorporated into a corresponding grinding tool. Alternatively or additionally, the interior portion can be defined by an excluded periphery defined on an absolute (or length) basis. For example the excluded periphery can be in a range of 0.25 cm to 5 cm or 1 cm to 2.5 cm (or about 0.1-2 inch or 0.5-1 inch), such as at least 0.25, 0.5, 0.75, 1, 1.25, or 1.5 cm and/or up to 1, 1.5, 2, 2.5, 3, 4, or 5 cm. As an illustration for a 7.5″×7.5″ (19.1 cm square) blank plate, the interior portion would be a 5.5″×5.5″ (14.0 cm square) central region for a 1″ (2.5 cm) excluded periphery, and the interior portion would be a 6.5″×6.5″ (16.5 cm square) central region for a 0.5″ (1.3 cm) excluded periphery.

In a refinement, the method further comprises: bonding the plurality of fixed-abrasive grinding segments to a base plate; and planarizing the plurality of fixed-abrasive grinding segments to a flattened state (e.g., a consistent height of initial grinding elements in a manufactured fixed-abrasive grinding tool).

In a refinement, the method for forming the resin blank plates comprises hot-pressing the mixture in a mold at a temperature in a range of 240° F. to 580° F. (or about 120° C. to 300° C.) and at a pressure of 200 psi to 2000 psi (or about 13.8 bar to 138 bar); the blank plate has a thickness in a range of 0.1 inch to 1 inch (or about 0.25 cm or 0.5 cm to 1 cm or 2.5 cm); and/or the blank plate has lateral dimension(s) in a range of 1 inch to 60 inch (or about 2.5 cm to 150 cm). More generally, the lateral dimension(s) can be at least 2, 5, 10, 15, 20, 25, 40, 60, or 80 cm and/or up to 4, 8, 12, 16, 20, 30, 40, 50, 70, 100, 120, or 150 cm. The lateral dimension(s) can define one of two opposing faces of the blank plate, such as length and width in a rectangular plate (which are identical in a square plate), diameter for a circular plate, etc.

In a refinement, the method for forming the vitrified blank plates comprises: cold-pressing the mixture in a mold at a temperature in a range of 50° F. to 200° F. (or about 10° C. to 90° C.) and at a pressure of 300 psi to 1000 psi (or about 20 bar to 70 bar) to form a green part, optionally drying the green part to remove water present in the mixture (e.g., as part of an adhesive or binder), firing the (dried) green part at a temperature in a range of 1000° F. to 1400° F. (or about 540° C. to 760° C.); the blank plate has a thickness in a range of 0.1 inch to 1 inch (or about 0.25 cm to 2.5 cm); and the blank plate has lateral dimension(s) in a range of 1 inch to 20 inch (or about 2.5 cm to 50 cm). More generally, the lateral dimension(s) can be at least 2, 5, 10, 15, 20, 25, or 40 cm and/or up to 4, 8, 12, 16, 20, 30, 40, or 50 cm. Firing generally includes heating at a controlled rate (e.g., 50-250° C./hr, 100-200° C./hr, or about 150° C./hr) until a target temperature is achieved, and then holding at the target temperature for up to 6 hr (e.g., 0-6 hr, 0.1-5 hr, 1-4 hr) before allowing the fired material to cool to ambient temperature naturally. No external pressure is generally applied during firing. Firing can be performed in an air atmosphere, but other inert or non-oxidizing atmospheres such as nitrogen or argon can be used.

While the disclosed compositions and methods are susceptible of embodiments in various forms, specific embodiments of the disclosure are illustrated (and will hereafter be described) with the understanding that the disclosure is intended to be illustrative, and is not intended to limit the claims to the specific embodiments described and illustrated herein.

### BRIEF DESCRIPTION OF THE DRAWINGS

FIG. 1 shows spray dried abrasive beads incorporating monocrystalline diamond according to an embodiment of the disclosure.

FIG. 2 illustrates a fixed-abrasive grinding tool incorporating a plurality of fixed-abrasive grinding plates or segments according to the disclosure.

FIG. 3 illustrates alternative structures for fixed-abrasive grinding tools according to the disclosure.

FIG. 4 illustrates a fixed-abrasive grinding plate according to the disclosure.

FIG. 5 is a graph showing an illustrative hardness distribution as a function of sampling position for a fixed-abrasive grinding plate according to the disclosure.

### DETAILED DESCRIPTION

The disclosure relates to fixed-abrasive grinding plates, fixed-abrasive grinding tools formed therefrom, and related methods. The grinding plate generally has a composite structure with abrasive beads (e.g., beads with diamond abrasives), a porosity additive, and an inorganic filler distributed throughout a binder matrix formed from a polymeric resin (e.g., a cured, thermoset resin). The grinding plate generally has a relatively low hardness, in particularly compared to other grinding and polishing materials such as those for lapping plates, making grinding tools formed from the plate (or segments thereof) particularly suitable for nano-grinding operations that can achieve very low surface roughness values with comparatively little substrate material removal. Such nano-grinding is particularly useful when machining a very smooth surface on advanced materials, such as sapphire, titanium carbide reinforced alumina (AlTiC), silicon carbide (SiC), gallium nitride (GaN), aluminum nitride (AlN), zinc selenide (ZnSe), and other compound semiconductor materials.

### Grinding Plate Compositions, Articles, and Methods

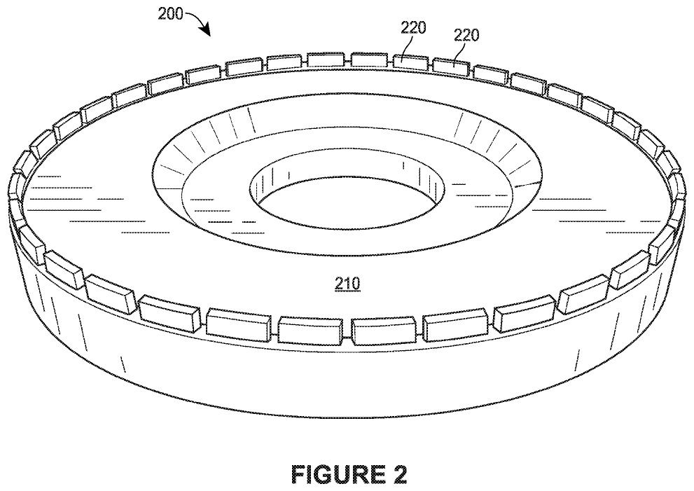

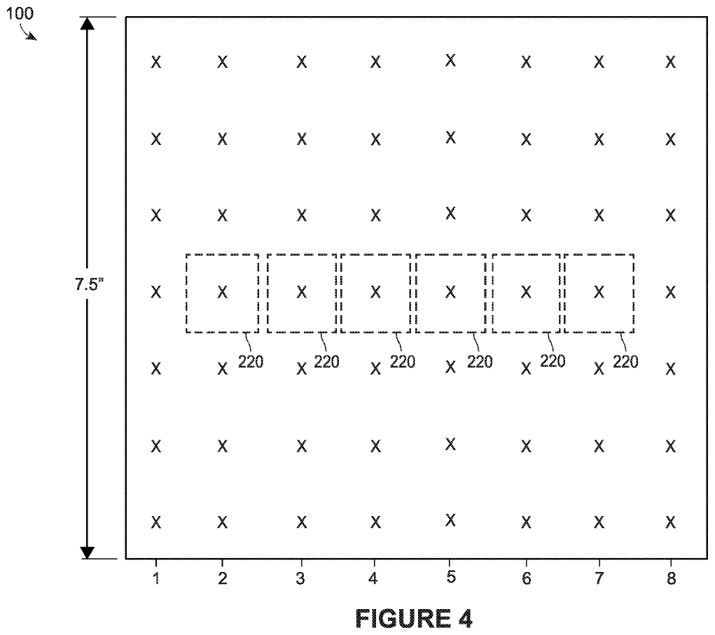

A fixed-abrasive grinding plate 100 (FIG. 4) according to the disclosure generally has a composite structure including about 30-95 wt. % of micron-sized composite abrasive beads, about 1-40 wt. % of one or more porosity additives, about 1-40 wt. % of one or more inorganic fillers, and about 3-40 wt. % of one or more polymeric resins. The polymeric resin provides a binder (or continuous binder matrix) for the abrasive beads, porosity additive, and inorganic filler bound by (or distributed throughout) the polymeric resin. A grinding plate or related component according to the disclosure that includes one or more polymeric resins as its composite matrix can be alternatively referenced herein as a resin grinding plate, resin grinding segment, resin tool, etc. FIG. 4 can equivalently represent a fixed-abrasive grinding plate 100 according to the disclosure that generally has a composite structure including about 30-95 wt. % of micron-sized composite abrasive beads, about 1-40 wt. % of one or more porosity additives, about 1-40 wt. % of one or more flux agents, and about 3-40 wt. % of a vitreous matrix. The vitreous matrix results from firing of a glass frit powder, and the resulting vitrified material provides a binder (or continuous binder matrix) for the abrasive beads, porosity additive, flux material, and any present inorganic filler bound by (or distributed throughout) the vitreous matrix. A grinding plate or related component according to the disclosure that includes a vitrified material as its composite matrix can be alternatively referenced herein as a vitrified grinding plate, vitrified grinding segment, vitrified tool, etc. A reference herein to a grinding plate, grinding segment, tool, etc., can generally apply to either the resin or vitrified embodiment. The foregoing amounts can be expressed on a dry weight basis relative to the total weight of the grinding plates. The components, amounts, and properties of the grinding plate 100 can similarly apply to grinding segments 220 of the plate 100 that are incorporated into a fixed-abrasive grinding tool 200 (FIG. 2) using the segments 220 as machining elements to contact a workpiece, such as during nano-grinding.

As described in more detail below, the composite abrasive beads can include diamond abrasive particles bound or coated by an inorganic metal oxide binder, among other types. The abrasive beads can be present in the grinding plate in an amount of at least 30, 35, 40, 45, 50, 55, 60, 65, or 70 wt. % and/or up to 50, 55, 60, 65, 70, 75, 80, 85, 90, or 95 wt. % relative to the grinding plate or segment thereof. The foregoing amounts can apply to the total amount of abrasive beads when more than one type of abrasive beads is present.

As described in more detail below, the porosity additive can include hollow glass spheres, among other types. The porosity additive can be present in the grinding plate in an amount of at least 1, 2, 3, 5, 7, 10, 15, or 20 wt. % and/or up to 10, 15, 20, 25, 30, 35, or 40 wt. % relative to the grinding plate or segment thereof. The foregoing amounts can apply to the total amount of porosity additives when more than one type of porosity additive is present.

As described in more detail below, the inorganic filler can include calcium carbonate and/or talc, among other types. The inorganic filler can be present in the grinding plate in an amount of at least 1, 2, 3, 5, 7, 10, 15, or 20 wt. % and/or up to 10, 15, 20, 25, 30, 35, or 40 wt. % relative to the grinding plate or segment thereof. The foregoing amounts can apply to the total amount of inorganic fillers when more than one type of inorganic filler is present.

As described in more detail below, the flux agent can include feldspar, among other types. The flux agent can be present in the grinding plate in an amount of at least 1, 2, 3, 5, 7, 10, 15, or 20 wt. % and/or up to 10, 15, 20, 25, 30, 35, or 40 wt. % relative to the grinding plate or segment thereof. The foregoing amounts can apply to the total amount of flux agents when more than one type of flux agent is present.

As described in more detail below, the polymeric resin can include a benzoxazine resin, a phenolic resin, and/or an epoxy resin, among other types. The polymeric resin can be present in the grinding plate in an amount of at least 3, 5, 7, 10, 15, 20, or 25 wt. % and/or up to 15, 20, 25, 30, 35, or 40 wt. % relative to the grinding plate or segment thereof. The foregoing amounts can apply to the total amount of polymeric resins when more than one type of polymeric resin is present.

As described in more detail below, the vitrified matrix can include silica and one or more of boron trioxide, sodium oxide, potassium oxide, aluminum oxide, calcium oxide, and barium oxide, among other oxides. The vitreous matrix can be present in the grinding plate in an amount of at least 3, 5, 7, 10, 15, 20, or 25 wt. % and/or up to 15, 20, 25, 30, 35, or 40 wt. % relative to the grinding plate or segment thereof. The foregoing amounts can apply to the total amount of vitreous matrix material when more than one type of oxide is present. The foregoing amounts can similarly apply to the amount of glass frit powder admixed with other grinding plate components when forming the initial blank plate.

The resin grinding plate generally can have a relatively low hardness to facilitate nano-grinding operations providing very smooth surfaces with low surface roughness and low removal rates for a wide range of workpiece materials. In embodiments, the grinding plate has a hardness value in a range of 20 to 120 on the Rockwell Hardness L scale. For example, the hardness value can be at least 20, 30, 40, 50, 60, 70, or 80 and/or up to 40, 50, 60, 70, 80, 90, 100, 110, or 120. The Rockwell Hardness value and scale is generally known in the art and can be measured using any suitable method and apparatus, for example ASTM D785. Rockwell testing is a general method for measuring the bulk hardness of a variety of materials, for example metallic materials, polymer materials, composite materials, etc. Although hardness testing does not give a direct measurement of any performance properties, hardness of a material correlates directly with its strength, wear resistance, and other properties. The Rockwell test measures the depth of penetration of an indenter under a large load (major load) compared to the penetration made by a preload (minor load). The equation for Rockwell Hardness is HR=N−hd, where d is the depth in mm (from the zero load point), and N and h are scale factors that depend on the scale of the test being used. For the Rockwell Hardness L scale, typically the minor load is 10 kgf, the major load is 60 kgf, the indenter can be a 0.25 in (6.35 mm) ball, N is 130, and h is 500.

The resin grinding plate can have a calculated density in a range 0.8 g/cm³ to 1.8 g/cm³ or 1.0 g/cm³ to 1.8 g/cm³. The vitrified grinding plate can have a calculated density in a range 0.7 g/cm³ to 1.3 g/cm³. In embodiments, either grinding plate can have a calculated density of at least 0.7, 0.8. 0.9, 1, 1.05, 1.1, 1.15, 1.2, 1.25, 1.3, or 1.4 g/cm³ and/or up to 1.1, 1.2, 1.3, 1.4, 1.5, 1.6, 1.7, 1.8, 1.9, or 2 g/cm³. For solid objects such as the grinding plate, volume can be determined by geometric measurement of dimensions/sides in order to calculate the volume of the object. The calculated density can then be determined based on the measured mass of the object divided by the calculated volume of the object. The calculated density represents a property corresponding to grinding plate suitability for nano-grinding. Similar to hardness, a lower calculated density indicates lower strength and may have better friability. In contrast, materials suitable for a lapping operation generally have higher hardness and/or higher calculated density values. The density of the grinding plate can be controlled or adjusted based on the pressing pressure when forming the grinding plate.

The relative and/or absolute amounts of components of the grinding plate can be selected to provide physical, mechanical, and/or chemical properties of the grinding plate (e.g., hardness) particularly suitable for nano-grinding. In particular, the binder plays a role in controlling the hardness and friability of the grinding plate. For example, in embodiments, a weight ratio of (i) the polymeric resin or the vitreous matrix to (ii) the porosity additive in the grinding plate can be in a range of 1 to 4 or 0.8 to 5, such as at least 0.8, 1, 1.2, 1.5, 2, or 2.5 and/or up to 1.7, 2, 2.2, 2.5, 3, 4, or 5. Alternatively or additionally, a combined amount of (i) the polymeric resin or the vitreous matrix and (ii) the porosity additive in the grinding plate can be at least 30, 35, 40, or 45 wt. % and/or up to 40, 45, 50, 55, or 60 wt. % on a dry weight basis of the grinding plate. Similarly, in embodiments, a weight ratio of (i) the polymeric resin or the vitreous matrix to (ii) a combined amount of the porosity additive and the inorganic filler in the grinding plate is in a range of 0.8 to 1.5 or 0.6 to 1.8, such as such as at least 0.6, 0.7, 0.8, 0.9, 1, 1.1, or 1.2 and/or up to 1, 1.1, 1.2, 1.3, 1.4, 1.5, 1.6, 1.7, or 1.8. Alternatively or additionally, a combined amount of the polymeric resin or the vitreous matrix, the porosity additive, and the inorganic filler or the flux agent in the grinding plate can be at least 45, 50, 55, 60, or 65 wt. % and/or up to 60, 65, 70, or 75 wt. % on a dry weight basis of the grinding plate. Alternatively or additionally, the hardness of the grinding plate can also be controlled by adjusting the compression pressure of mixture components when forming the plate. For example, the applied compression pressure can be about 200 psi to 2000 psi (or about 13.8 bar to 138 bar) or 1000 psi to 1200 psi (or about 68.9 bar to 82.7 bar).

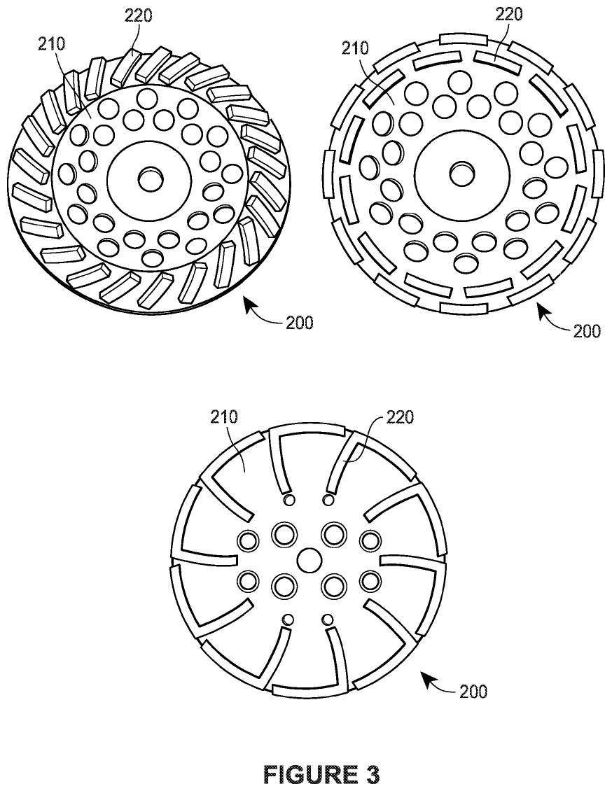

FIG. 2 illustrates a fixed-abrasive grinding tool 200 according to the disclosure. The tool 200 includes a base plate 210, which can be a steel, stainless steel, other metal, or other support substrate adapted to be rotated in a machining process (e.g., nano-grinding) using the tool 200. A plurality of fixed-abrasive grinding segments 220 are mounted to the base plate 210, for example as separate, individual grinding elements on the base plate 210. The grinding segments 220 can generally have the same components, amounts, and properties of the grinding plate 100 as described above, for example where suitably sized/shaped segments 220 are cut from a singular grinding plate 100 and bound, mounted, or otherwise affixed to the base plate in a desired orientation. FIG. 3 illustrates other representative structures of a grinding tool 200 according to the disclosure, all of which include a support or base plate 210 onto which a grinding segments 220 are mounted.

The particular structure of the fixed-abrasive grinding tool is not particularly limited. In embodiments, the fixed-abrasive grinding tool is in the form of a grinding wheel, for example a cup wheel as illustrated in FIG. 2. In contrast to a unitary lapping plate structure, a grinding wheel tool typically includes a plurality of separate, distinct grinding (or nano-grinding) elements. Grinding wheels are available in wide range of shapes (generally called “types”), which are typically accepted standards from ANSI B74.2. For most applications, the correct wheel shape can be selected from these standard configurations. Examples of representative grinding wheel shapes/configurations include straight, cylinder, recessed 1 side, recessed 2 sides, saucer, straight cup, flaring cup, dish, cone, square plug, round plug, relieved 1 side, relieved 2 sides, relieved 1 side and recessed other side, relieved and recessed 1 side, relieved 1 side and recessed 2 sides, relieved 2 sides and recessed 1 side, relieved and recessed 2 sides, raised hub disc wheel, and raised hub dish wheel.

The grinding tool 200 can be used to machine any of a variety of substrates or workpieces (e.g., by rotating the grinding tool at high speeds and then contacting the substrate with the rotating tool). In embodiments, the substrate or workpiece can include an advanced material, such as one or more of sapphire, titanium carbide reinforced alumina (AlTiC), silicon carbide (SiC; e.g., (α)3C-SiC, 4H-SiC, (β)6H-SiC), gallium nitride (GaN), aluminum nitride (AlN), zinc selenide (ZnSe), silicon wafers (e.g., semiconducting silicon, such as crystalline silicon), and other compound semiconductor materials. In other embodiments, the substrate or workpiece can include a glass, ceramic, metal, or (polymer) composite material.

In embodiments, the machining method includes performing nano-grinding as a grinding operation on the substrate. In general, a grinding step can be a high stock removal step with large diamond sizes, while a nano-grinding typically uses an abrasive with submicron abrasive particles to achieve a good surface finish with little or no material removal. Most grinding wheels use higher grit diamond in a vitreous bond to give fast stock removal without regard to surface finish. Using sub-micron diamond abrasives directly in vitreous bond results in oxidation/graphitization of most of the diamond due to the high temperature condition of the vitreous process in grinding, and the diamond abrasives left are usually aggregated. By incorporating the diamond into bead, it assures that the diamond abrasives are well dispersed. Oxidation and/or graphitization of the diamond abrasives are avoided by incorporating the diamond abrasive beads into a resin-bonded grinding plate formulation which are processed at much lower temperature (e.g., 120° C. to 300° C., such as at least 120, 150, or 180° C. and/or up to 200, 250, or 300° C.). By using submicron diamond abrasive beads (e.g., 5-40 μm beads with nano-scale diamond abrasives) in the grinding plates and grinding segments according to the disclosure, the grinding plates are particularly suitable for nano-grinding to provide low stock removal but superior surface finish of the workpiece. This reduces the grinding and polishing times and improves overall processing efficiency.

As described above, nano-grinding typically achieves a good surface finish with little or no material removal, in particular when using a resin grinding plate or tool. In embodiments, the substrate has an initial surface roughness Ra of at least 30 nm or at least 10 nm prior to nano-grinding; the substrate has a final surface roughness Ra of not more than 1 nm subsequent to nano-grinding; and/or an average material removal rate from the substrate is not more than 1 μm/min while nano-grinding (e.g., between initial and final states of the substrate). The surface roughness Ra can represent an average, arithmetic mean of profile height deviations from the mean line of a surface. In embodiments, the initial surface roughness Ra can be at least 10, 20, 30, 40, 50 nm and/or up to 40, 60, 80, or 100 nm. Alternatively or additionally, the final surface roughness Ra can be up to 0.1, 0.2, 0.4, 0.6, 0.7, 0.8, 0.9, or 1 nm and/or at least 0.01, 0.02, 0.05, 0.1, 0.2, 0.3, 0.4, 0.5, or 0.6 nm.

The surface finish additionally can be characterized by the roughness parameter Rt, which is the vertical distance between the highest peak and lowest peak of a surface roughness profile within the overall measuring distance (i.e., maximum peak to valley height). In other words, this is the height difference between the highest mountain and lowest valley within the measured range. In embodiments, the final surface roughness Rt can be at least 0.1, 0.2, 0.5, 1, 2, 4, or 6 nm and/or up to 10, 12, 15, 20, 25, or 30 nm.

The surface finish additionally can be characterized by the roughness parameter Rv, which is the average valley depth over the measurement surface(s). In embodiments, the final surface roughness Rv can be between 0 nm and −25 nm or 0 nm and −10 nm, for example at least −25, −20, −15, −10, −8, −7, −6, or −5 nm and/or up to −4, −3, −2, −1, or 0 nm.

As described above, nano-grinding can achieve a good removal rate, in particular when using a vitrified grinding plate or tool. In embodiments, the substrate has an initial surface roughness Ra of at least 100 nm, 200 nm, or 300 nm prior to nano-grinding or other machining; the substrate has a final surface roughness Ra of not more than 5 nm subsequent to nano-grinding or other machining; and/or an average material removal rate from the substrate is in a range of 1.5-10 μm/min or 2-8 μm/min while nano-grinding or other machining (e.g., between initial and final states of the substrate). In embodiments, the initial surface roughness Ra can be at least 50, 100, 150, 200, 300, or 400 nm and/or up to 200, 400, 600, or 1000 nm. Alternatively or additionally, the final surface roughness Ra can be up to 2, 2.5, 3, 3.5, 4, 4.5, or 5 nm and/or at least 1, 1.2, 1.5, 2, or 2.5 nm. Alternatively or additionally, the removal rate can be at least 1.2, 1.5, 1.7, 2, 2.5, or 3 μm/min and/or up to 3, 5, 7, or 10 μm/min.

### Abrasive Beads

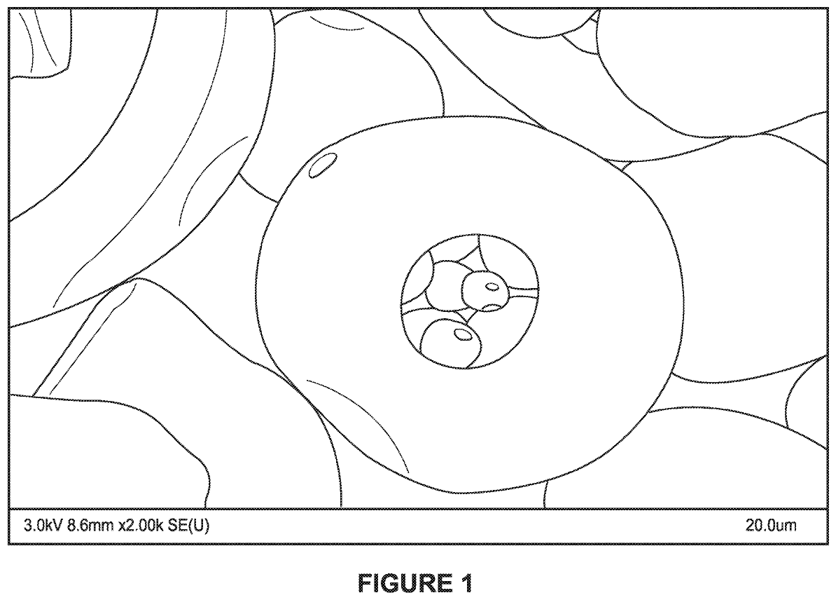

Abrasive beads, for example diamond abrasive beads, are formed by a spray drying process. A slurry of abrasive particles is made by dispersing abrasive grains in a liquid carrier in the presence of inorganic binder, dispersing agent and/or plasticizer. The constituents are mixed thoroughly with a propeller mixer or ultrasonic mixer or other appropriate dispersing mechanisms to give a uniformly dispersed abrasive slurry. The slurry is then spray dried to form spherical abrasive beads (FIG. 1). Suitable abrasive grains for embodiments of the present disclosure generally have Mohs hardness of greater than 5. Examples of abrasive grains includes carbides, for example, silicon carbide and titanium carbide; oxides, for examples, alumina, zirconium oxide, silicon oxide, etc.; nitrides, for example, cubic boron nitride, titanium nitride, silicon nitride, etc.; and monocrystalline, polycrystalline, and surface etched synthetic diamond, as well as natural diamond. Diamond is selected as an abrasive grain in some embodiments because of its hardness and chemical inertness.

In some embodiments, the abrasive beads are a composite of a mixture of abrasives or a composite of an abrasive and a metal oxide, such as an inorganic metal oxide. In some embodiments, the abrasive beads are spherical. In some embodiments, micron-sized abrasive spherical beads have an average particle size of 5 microns to 50 microns. In some embodiments, the abrasive particles contained in the abrasive beads have an average size of 0.01 microns to 10 microns.

The abrasive grains come in different sizes from nano sizes to micron sizes and shapes from 3-D blocky shapes to 2-D shapes, and surface roughness values ranging from smooth to rough. The abrasive grains may be coated with organic, inorganic, or metallic coatings. The size range of the abrasive grains may be from about 5 nm to about 12 microns in some embodiments, from about 50 nm to about 7 microns in other embodiments, and less than about 4 microns in yet other embodiments. The abrasive grain composition of the slurry for spray drying is between about 1 wt. % and about 50 wt. % in some embodiments, and between about 5 wt. % and about 35 wt. % in other embodiments, based on the weight of the slurry for spray drying. In some embodiments of the disclosure, mixtures of two or more particle sizes are used for desired lapping/polishing results.

In some embodiments, the abrasive particles are super abrasive particles. The super abrasive particles include: natural diamond, synthetic diamond and cubic boron nitride.

The abrasive grains are subsequently mixed with inorganic metal oxide binder to form sprayable slurries/sols in some embodiments. The metal oxide binder forms a friable continuous matrix holding the plurality of the abrasive grain particles together. Suitable metal oxide binders include ceria, silica, zirconia, alumina, titanium dioxide, magnesium oxide, and mixtures thereof. In many embodiments, silica is used as the metal oxide binder. Silica is available as colloidal silica from many commercial manufactures. Some suitable commercially available colloidal silica are: NEXSIL 5, NEXSIL 6, NEXSIL 8, NEXSIL 12, NEXSIL 20, NEXSIL 20A, NEXSIL 20K-30, NEXSIL 20NH4, NYACOL DP9711 (from Nyacol Nano Technologies, Inc. Ashland, Massachusetts), BENDZIL 2040, LEVASIL 2050, LEVASIL F01440, MEGASOL S50, (Wesbond Corporation, Wilmington, Delaware), NALCO 1050, NALCO 1060, NALCO 1130, NALCO 2326, NALCO 2360 (Nalco, Naperville, Illinois) LUDOX SM30, LUDOX HS30, LUDOX AM30, LUDOX PX30, REMASOL SP30, REMASOL LP40 AND REMASOL LP40 (from Remet Corporation, Utica, New York). Different sizes of colloidal silica could be used from about 5 nm to about 200 nm in some embodiments, from about 5 nm to about 100 nm in other embodiments, and from about 5 nm to about 60 nm in yet other embodiments. The sprayable abrasive grain and metal oxide binder slurry has a solid content of about 5 wt. % to about 60 wt. % in some embodiments and about 10 wt. % to about 50 wt. % in other embodiments, based on the weight of the slurry. The metal oxide binder content of the sprayable abrasive mixture is between about 1 wt. % and about 90 wt. %, in some embodiments and between about 10 wt. % and about 80 wt. % in other embodiments on a basis of the dry components.

In some embodiments, the sprayable abrasive slurry mixture composition includes a dispersant and or humectant. Dispersants aid in dispersing and stabilizing the abrasive particles in the slurry. They are organic, inorganic or polymeric agents capable of suspending the particles in the sprayable slurry. Suitable dispersants include polyvinyl alcohol, polyvinyl butyral, polyvinyl pyrrolidinone of low to medium molecular weight, cellulose, and cellulose derivatives; for example carboxymethyl cellulose, hydroxyethyl cellulose, and sodium alginate. Other examples include sucrose, maltose, lactose, low to medium molecular weight polyethylene glycol and any combination thereof. To reduce quick drying of the slurry inside the nozzles, humectants may be added to the sprayable slurry. Humectants are low evaporating solvents or soluble organic or inorganic salts capable of retaining water. Exemplary humectants are glycerin, polyols, and polyethylene glycols. In some embodiments, sucrose is the dispersant.

The dispersed sprayable diamond slurry is nebulized into droplets in a spray dryer and dried to fine powder at a temperature of about 170° C. The dried particles formed are collected at the cyclones. Large particles and aggregates collected at the bottom of the main drying chamber of the dryer are rejected. The inorganic metal oxide binder forms identifiable spherical particles embedded with diamond particles. While the formed beads are identifiable particles, the metal oxide binders and the diamond grains are not fused/sintered at the spraying temperature and can be broken under certain shear conditions. Spray dried diamond beads in some embodiments of the disclosure exhibit a wide particle size distribution with a mean diameter between about 12 microns to about 25 microns. The average diamond bead size can be manipulated by changing the spray drying process parameters and/or the composition of the sprayable slurry. Common classification or grading techniques are used to separate the beads into desired narrow mean sizes and, respectively, narrow particle size distributions.

In another embodiment, the inorganic metal binders, silica, ceria, titanium dioxide and alumina or mixtures thereof, were spray dried without abrasive particles in the presence of dispersants and humectants to form metal oxide beads, such as silica beads. Silica beads were used in conjunction with diamond abrasive to form 3-dimensional fixed abrasive plates for lapping/polishing silicon carbide wafers in some embodiments.

In some embodiments, the inorganic metal oxide beads are micron-sized inorganic metal oxide beads having an average particle size of 5 microns to 50 microns. In some embodiments, the inorganic metal oxide beads are spherical.

### Polymeric Resins and Vitrified Materials

Graded diamond or other abrasive beads are then used in different formulations to make fixed abrasive grinding plates 100. The fixed abrasive plate 100 can be made in one piece as shown in FIG. 4. The large piece can be sliced into smaller segments 220 for incorporation into a fixed abrasive grinding tool 200. For example, the segments 220 can be bonded to base wheel 210 to make diamond grinding wheels and other grinding tools for nano-grinding of ceramics and other hard materials. In addition to the diamond beads, the 3-dimensional fixed abrasive plate of the present disclosure may contain polymeric resin or a vitrified material as a composite matrix, fillers and/or flux agents, and porosity additives.

Polymeric resins suitable for embodiments of the disclosure include Araldite MT35700 epoxy resins, bisphenol A modified epoxy resins, phenolic resins, polybenzoxazine, bismaleimides, polyetherimide, PEI, polyether ether ketone, PEEK from Huntsman (Woodland, TX), epoxy Novolac resins, and their curing agents. Examples of commercially available epoxy resins are Dow Chemical's (Midland, Michigan) D.E.R 330, D.E.R 335, D.E.R 671, D.E.R 640, DEH 84, and DEH 85; Huntsman's (Woodland, Texas) Araldite PY 282, 304 and GY 280, 253, 505, 502, and EPN 1179; and Hexion's (Columbus, Ohio) EPON resin phenolic epoxy resin series, EPON 825, 828, 862, and 813. Other suitable polymeric resins are unsaturated polyester resin, urea formaldehyde resin, melamine formaldehyde resin, base-catalyzed phenolic resin, and acid-catalyzed phenolic resin. Examples of commercially available phenolic resins are: BAKELITE PF02245P, DURITE RESIN AD3237, and DURITE RESIN AD5534, from Hexion in Columbus, Ohio; PLENCO 14043 from Plastics Engineering Company, Sheboygan, Wisconsin; VARCUM 29310, 28108, 29318, 29334, 28317, 28101, 29008, 29108, and 29319 from SBHPP, Novi, Michigan. In some embodiments, suitable polymeric resins include powdered phenolic resins and their derivatives. Using powdered phenolic resin allows for incorporation of higher volume percentage of diamond beads and fillers. Phenolic resins also provide higher temperature resistance and plate hardness necessary for high stock removal during lapping. The composition of the phenolic resin in the 3-dimensional fixed abrasive formulation is from about 5 wt. % to about 60 wt. % in some embodiments, and from about 5 wt. % to about 35 wt. % in other embodiments based on the weight of the abrasive plate.

While phenolic resin is used in some embodiments, other common binders, such as unsaturated polyester, epoxy, acrylic polyol, etc., are used in other embodiments. Similar porosity can be achieved with foam binders like polyurethane binders, which form a porous network structure.

The vitrified matrix is generally a continuous material including silica as well as one or more other materials or oxides such as boron trioxide and a variety of different metal oxides (e.g., alkali metal oxides and alkaline earth metal oxides). The vitrified matrix can be formed by firing or otherwise sufficiently heating one or more glass frit powders to a temperature above their fusing or softening point. The glass frit powders are typically finely ground with a particle size of about 30-800 microns (e.g., as a breadth of the size distribution). The vitreous bonds in the vitrified matrix essentially include metal silicate bonds, for example alkali metal aluminoborosilicate bonds (i.e., depending on the specific oxides and materials included in the glass frit powders and flux agents). The vitrified matrix bonds the abrasive beads and the porosity additive in the grinding plate, and it is generally not a very homogeneous material. Examples of specific oxides present in the glass frit powders and the corresponding vitrified matrix include silica (SiO₂), lithium oxide (LiO), sodium oxide (Na₂O), potassium oxide (K₂O), boron trioxide (B₂O₃), aluminum oxide (Al₂O₃), calcium oxide (CaO), magnesium oxide (MgO), barium oxide (BaO), zirconium oxide (ZrO), zirconium dioxide (ZrO₂), titanium dioxide (TiO₂), zinc oxide (ZnO), calcium difluoride (CaF₂), manganese dioxide (MnO₂), and bismuth trioxide (Bi₂O₃). Silica is typically the primary or most abundant individual component in the vitrified matrix or glass frit, for example being present in an amount of at least 20, 30, 40, or 50 wt. % and/or up to 30, 40, 50, 60, 70, or 80 wt. % relative to the matrix or frit powder. In embodiments, when present, boron trioxide can be a primary or secondary component, for example being present in an amount of at least 2, 3, 5, 8, 10, 14, 20, 30, or 40 wt. % and/or up to 5, 10, 20, 30, 40, 50, or 60 wt. % relative to the matrix or frit powder. Various other metal oxides can be present as secondary components, for example being individually present in an amount of at least 2, 3, 5, 8, 10, or 12 wt. % and/or up to 5, 10, 20, or 30 wt. % relative to the matrix or frit powder. Some metal oxides can be present in only minor amounts, such as at least, up to, or not more than 0.001, 0.01, 0.1, 1, 2, 3, or 5 wt. % relative to the matrix or frit powder. Examples of suitable glass frit compositions (w/w) include the following: (A) silica 34-41%, alumina 13-19%, boron trioxide 25-31%, calcium oxide <2%, sodium oxide 11-16% and potassium oxide 2-6%; (B) silica 39-45%, alumina 11-15%, boron trioxide 26-31%, calcium oxide 2-5% and magnesium oxide 10-14%; (C) silica >20% (balance), boron trioxide 5-20%, alumina 5-20%, sodium oxide 5-20%, potassium oxide <5%, lithium oxide <5%, calcium oxide <5%, magnesium oxide <5%, zirconium dioxide <5%, titanium dioxide <5% and bismuth trioxide <5%; (D) silica >20% (balance), boron trioxide 5-20%, sodium oxide 5-20%, calcium oxide 5-20%, magnesium oxide <5% and zinc oxide <5%; and (E) silica >20%, boron trioxide >20%, alumina 5-20%, sodium oxide 5-20%, potassium oxide 5-20%, calcium oxide 5-20%, and magnesium oxide 5-20%. Suitable commercially available glass frit powders are available from Ferro Corporation (Cleveland, OH). The specific composition or component distribution of the glass frit can be selected based on a particular grinding plate operation. For example, for abrasive beads (e.g., diamond beads) with a specific inorganic metal oxide binder, a glass frit can be selected for compatibility with and/or adhesion to either or both of the inorganic metal oxide binder and the abrasive material itself. For example, a glass frit power and corresponding vitreous matrix can be selected that has a substantial portion (e.g., at least 10, 20, 30, or 40 wt. % and/or up to 15, 25, 35, 50, 65, or 80 wt. %) of the same material(s) used as the inorganic metal oxide binder.

### Inorganic Fillers and Flux Agents

In another embodiment, the 3-dimensional fixed abrasive plate contains filler materials, for example inorganic fillers. Fillers are cheap non-functional materials used to reduce cost without any negative impact on the performance of the lapping plate. Fillers help to increase the wear rate of the polymer binders, thereby constantly exposing new diamond beads. Fillers prevent the diamond from dulling, thereby maintaining constant cutting action for the life of the lapping plate. Some suitable fillers are ground and precipitated calcium carbonate, talc, kaolin, hydrated aluminum silicate, calcium metasilicate, alumina, and clay or combinations thereof. Ground calcium carbonate is the filler in some embodiments. Examples of commercially available calcium carbonate from Specialty Minerals of Adams, MA, are ALBACAR 5970, ALBAGLOS PCC, ALBACAR 8101, and VICRON GCC. The particle size of the calcium carbonate is between about 1 micron and about 30 microns and the concentration of the filler is from about 1 wt. % to about 40 wt. % in some embodiments and between about 5 wt. % and about 30 wt. % in other embodiments.

The 3-dimensional fixed abrasive plate additionally can contain one or more flux agents, in particular when a vitrified material is used as the composite material. Flux agents are generally known in the art and can be added to lower or otherwise adjust the melting or processing temperature required to transform the original glass frit powder into the resulting continuous vitreous matrix. Examples of suitable flux agents include clay, kaolin, feldspar (an aluminum tectosilicate), borax (a hydrated or anhydrous borate of sodium), talc, wollastonite (calcium metasilicate), alkali metal nitrates (e.g., lithium, sodium, and/or potassium nitrates), alkali metal carbonates (e.g., lithium, sodium, and/or potassium carbonates), and combinations or mixtures thereof. The concentration of the flux agent is from about 1 wt. % to about 40 wt. % in some embodiments and between about 5 wt. % and about 30 wt. % in other embodiments. Upon firing, the flux agent combines with the glass frits to become one vitreous bond and form a single (e.g., continuous) matrix material. The flux agent is generally in a fine powder of any suitable particle size when combined with the glass frit powder before firing.

### Porosity Additive

For efficient removal of the swarf and maintenance of constant cutting rate, the 3-dimensional fixed abrasive plate is designed with plurality of pores in the plate. Pores on the surface of the plate form discontinuous lapping lands and provide channels for lapping lubricant to flow and prevent hydroplaning of the workpiece. The resultant debris/swarf is washed into the pores to avoid scratching of the workpiece. Embodiments of the disclosure control the surface porosity of the plate. Hollow glass spheres were added in the formulation of the 3-dimensional fixed abrasive plate to increase and control porosity of the plate. Some examples of commercially available hollow glass spheres applicable to embodiments of the disclosure are: 3M Glass bubble series S32, S15, S22, K37, K20, 38HS, and K1 from 3M Advanced Materials, St. Paul, Minnesota; EXTENDOSPHERE series TG, SGT, SLG, CG, SG, and TG from Sphere One, Chattanooga, Tennessee; SPHERICEL series of hollow glass spheres from Potters Industries LLC, Valley Forge, Pennsylvania. The amount of hollow glass spheres in the formulation is between about 1 and about 50 wt. % in some embodiments, between about 1 and 40 wt. %, and between about 5 and about 30 wt. % in other embodiments. Particle size distribution of the hollow glass spheres is the range of about 1 to about 500 microns in some embodiments. EXTENDOSPHERE SG hollow glass spheres are used in some embodiments of the disclosure.

The wide particle size distribution of the hollow glass spheres gives the 3-dimensional fixed abrasive bead plate a mixture of pore sizes. There are also pores caused by packing structure of the spherical diamond beads. The interstices of the packing structure are partially filled with resin to bond them together. The diamond beads themselves are porous (FIG. 1). There are holes in majority of the beads, and the solid mass of the beads is porous since the silica binder is not sintered. That is why the beads are friable and easy to abrade to expose the diamond. There are also pores due to entrapped air during mixing and/or curing. The extent of entrapped air is controlled by molding pressure. Excessive molding pressure will squeeze out entrapped air and decrease the interstices and overall porosity of the plate. Stock removal rate efficiency of the workpiece depends on total porosity of the plate. 3-dimensional fixed abrasive diamond bead plates with little to no porosity do not give a good stock removal action.

Surface porosity may be analyzed by different techniques. Optical interferometry and stylus profilometry may be used to measure the surface profile (roughness) and calculate the surface porosity. Bulk porosity measurement methods, such as x-ray computed tomography, may also be used to calculate the surface porosity. Gas adsorption or liquid intrusion porosimetry is not adequate due to the closed nature of some pores. 3-D optical image analysis was used to quantify surface porosity in embodiments of this disclosure. 3-dimensional fixed abrasive bead plate surface porosity was measured by optical image analysis of high resolution 3D images of the plate. The percent surface area with pores are mapped and calculated to give the percent porosity of the plate surface, or surface area porosity, at a given magnification. The percent surface area porosity is a measure of the areas with pores compared to the total area of the plate. The minimum surface area porosity of the plate for a good cut rate is about 3% in some embodiments, in some embodiments the porosity is greater than 10%. Above 60% porosity, the integrity of the plate suffers, and the cut rate drops off fast and surface finish may be compromised.

Some embodiments will not work properly if the diamond beads are sintered so the inorganic metal oxide binder is hard to abrade or there is a significant reduction in porosity. Also, if the diamond beads are so porous that they are easy to compress under pressure the surface porosity will be reduced. Excessive porosity will lead to a frail plate with a high wear rate and a very low life cycle. For best performance, the plate surface porosity should be between about 5% and about 60% of the surface area. The diamond beads and plate should be able to withstand aqueous treatment without changing porosity.

### EXAMPLES

The following examples illustrate the disclosed compositions, articles, and methods, but are not intended to be limiting.

### Preparation Example 1—Diamond Abrasive Beads

851.9 grams of REMASOL SP30 colloidal silica slurry (commercially available from Remet Corporation, Utica, New York) was mixed with 8.1 grams of sucrose and 140 grams of 1.25 μm monocrystalline diamond in a 2-liter glass beaker with a propeller mixer for 20 minutes. Then the slurry was dispersed further for 20 minutes with an ultrasonic disperser. The resultant slurry was spray dried using a Yamato ADL311 spray dryer (Yamato Scientific America Inc., Santa Clara, California) equipped with a #4 nozzle assembly having 1530 μm orifice. The slurry was under constant agitation before feeding into the inlet tube and flows into the spray chamber at inlet temperature of 170° C. The spray drying process entails feeding the slurry into the nozzle chamber with a peristaltic pump. The slurry is atomized as it passes through the orifice by pressurized air into the drying chamber at an inlet temperature of 170° C. Water is stripped from the slurry droplets to form discrete particles containing diamond in a silica matrix and sucrose. The discrete powder particles are separated by the cyclone into the collection jar while steam is exhausted. Oversized particles and aggregates collected at the bottom of the drying chamber are discarded as waste. The outlet temperature is about 96° C. The diamond slurry according to this recipe provided a yield of 85% diamond beads. Analysis of the beads by scanning electron microscopy (SEM) shows spherical particles with distinct features of porosity. The beads have a mean particle size of 19 μm as measured with MULTISIZER 3 Coulter Counter from Beckman Coulter Inc. Collected diamond beads were subsequently graded to a mean particle size of 23 μm.

### Preparation Example 2—Diamond Abrasive Beads

Diamond beads were prepared by mixing 630 grams of REMASOL SP30 colloidal silica slurry (REMASOL SP30 is a 30 wt. %, 8 nm colloidal silica in water, commercially available from Remet Corporation, Utica, New York) with 6.0 grams of sucrose, 103.6 grams of 0.25 μm monocrystalline diamond and diluted with 260.4 grams of de-ionized water in a 2-liter glass beaker with a propeller mixer for 20 minutes to form a diamond slurry. The slurry was dispersed further for 60 minutes with an ultrasonic disperser. The resultant slurry was spray dried with a Yamato ADL311 spray dryer (Yamato Scientific America Inc., Santa Clara, California) equipped with #4 nozzle assembly having 1530 μm orifice. The slurry was under constant agitation before feeding into the inlet tube and flows into the spray chamber at inlet temperature of 170° C. Water is stripped from the slurry droplets to form discrete particles containing diamond in silica matrix and sucrose. The discrete particles are separated by the cyclone into the collection jar while steam is exhausted. Oversized particles and aggregates collected at the bottom of the drying chamber are discarded as waste. The outlet temperature is about 96° C. The diamond slurry according to this recipe provided a yield of 81 wt. % of diamond beads. Analysis of the beads by scanning electron microscopy (SEM) shows spherical particles with distinct features of porosity. The beads have a mean particle size of 18 μm as measured with MULTISIZER 3 Coulter Counter from Beckman Coulter Inc. Collected diamond beads were subsequently graded to a mean particle size of 23 μm.

### Preparation Example 3—Diamond Abrasive Beads

Diamond beads were prepared by spray drying as described in Preparation Example 2, except that 0.4 μm monocrystalline diamond powder was used instead of 0.25 μm monocrystalline diamond.

### Preparation Example 4—Diamond Abrasive Beads

Diamond bead powders were prepared by spray drying as described in Preparation Example 2, except that 3 μm monocrystalline diamond powder was used instead of 0.25 μm monocrystalline diamond.

### Preparation Example 5—Diamond Abrasive Beads

Diamond beads were prepared by mixing 926.6 grams of NYACOL TiSol A, colloidal titanium dioxide of 14 wt. % solids, (commercially available from NYACOL Nano Technologies, Inc., Ashland, Massachusetts) was mixed with 3.3 grams of sucrose, and 70 grams of 0.25 μm monocrystalline diamond in a 2-liter glass beaker with a propeller mixer for 20 minutes to form a diamond slurry. The slurry was dispersed further for 60 minutes with an ultrasonic disperser. The resultant slurry was spray dried with a Yamato ADL311 spray dryer (Yamato Scientific America Inc., Santa Clara, California) equipped with #3 nozzle assembly having a 711 μm orifice. The slurry was under constant agitation before feeding into the inlet tube and flows into the spray chamber at inlet temperature of 170° C. Water is stripped from the slurry droplets to form discrete particles containing diamond in a titania matrix and sucrose. The discrete particles are separated by the cyclone into the collection jar while steam is exhausted. Oversized particles and aggregates collected at the bottom of the drying chamber are discarded as waste. The outlet temperature is about 84° C. The diamond slurry according to this recipe provided a yield of 78 wt. % diamond beads. Analysis of the beads by scanning electron microscopy (SEM) shows spherical particles with distinct features of porosity. The beads have a mean particle size of 14 μm as measured with a MULTISIZER 3 Coulter Counter from Beckman Coulter Inc.

### Example 1—Nanoprinting of SiC Wafer with Resin Fixed-Abrasive Grinding Plate

A 3-dimensional fixed diamond abrasive plate blank was prepared by thoroughly mixing all the powder components of: 126 g of graded diamond beads of 250 nm monocrystalline diamond (from Engis Corp. Wheeling, IL), 75.6 g of ARALDITE MT35700 powder resin (from Huntsman, Woodland, Texas), 8.4 g of EPON SU8 epoxy solid resin (from Hexion, Columbus, Ohio), 27.6 g of talc powder and 27 g of graphite. Also added was 2.4 g of manganese chloride (from Sigma Aldrich), 6 g of potassium permanganate (from Sigma Aldrich) and 27 g of SPHERICEL 34P30 glass hollow spheres (from Potters Industries LLC, Valley Forge, Pennsylvania). The powder components were thoroughly mixed in a rotary mixer and poured into 7.5-inch (19 cm) square hot press mold. The powder mix was leveled, and the flange replaced to make a tight fit. The mold and content were put onto a preheated 30 ton Wabash 15″×15″ (38 cm×38 cm) platen hot press (Wabash MPI, Wabash, Indiana). The mold was heated to 402° F. (206° C.) and hot pressed at pressure of about 1060 psi (73 bar) for 10 minutes to form a rigid 3-dimensional fixed abrasive lap plate blank. The rigid blank plate was mounted on a 12-inch (30.5 cm) square cast iron base plate with the aid double sided adhesive tape. Both sizes of the plate were planarized and reduced to a thickness of 4.0 mm. The planarized rigid blank plate of 4.0 mm thickness can be cut into 20.5 mm×9.0 mm rectangles to form grinding plate segments by any known method such as rotary cutters, waterjet cutters, laser cutters, diamond wire cutters, electrical discharge machining (EDM) etc. A waterjet cutter method was used to cut the blank plates to create diamond bead plate segments. The diamond bead plate segments are mounted on the periphery/rim of a 12-inch (30.5 cm) diameter base wheel with the aid of epoxy adhesive to make a segmented grinding cup wheel as shown in FIG. 2. The mounted segments are planarized to equal height and the segmented cup wheel is balanced before testing.

The balanced segmented cup wheel is fixed to EVG300 vertical grinder (from Engis Corp., Wheeling, IL) equipped with ceramic vacuum chuck rotary table. The segmented grinding wheel is positioned a wheel radius off from the rotational axis of the rotary table. The sample workpiece is 4″ (10.2 cm) SiC wafer 4H-SiC. The work piece is secured at the center of the ceramic vacuum chuck at a pressure less than −0.8 atmospheres (−0.81 bar). During nano-grinding operation, both cup wheel and the rotary table rotates in the same direction. The grinding cup wheel rotates at speed of 1900 RPM counterclockwise, while the vacuum chuck rotary table rotates at 100 RPM in the same direction of the cup wheel. Initial feed rate of the cup wheel is 0.2 μm/min as it encounters the work piece and it is reduced in the final 10% set wheel z-position (m), to 0.05 um/min to ensure better surface finish and planarization. The cup wheels are additionally dressed using an electroplated diamond dressing (DI-FLEX, available from Engis Corporation), with diamond grit size of 100/120. Deionized water with flow rate of 8-9 L/min is used as a coolant. The difference in measured wafer thickness before and after processing is used to indicate the sample material removal rate. The wheel wear rate is calculated based on the changes in height of the wheel segments before and after processing and is measured using the Mituyo drop gauge indicator. The ratio of the sample removal rate and the wheel wear rate determines the grinding ratio. Surface roughness is measured using Zygo NEWVIEW 6k Optical Profilometer. The 250 nm diamond bead cup wheel plate gave a polished Ra of 0.84 nm as shown in Table 1 below.

### Example 2—Nanogrinding of SiC Wafer with Resin Fixed-Abrasive Grinding Plate

A 3-dimensional fixed diamond abrasive plate blank was prepared by thoroughly mixing all the powder components of: 105 g of graded diamond beads of 500 nm monocrystalline diamond, 62.5 g of ARALDITE MT35700 resin (from Huntsman, Woodland, Texas), 22.5 g of EPON SU8 epoxy resin (from Hexion, Columbus, Ohio), 37.5 g of talc, and 22.5 g of SPHERICEL 34P30 glass hollow spheres. The powder components were thoroughly mixed in a rotary mixer and poured into 7.5-inch square hot press mold. The powder mix was leveled, and the flange replaced to make a tight fit. The mold and content were put onto a preheated 30 ton Wabash 15″×15″ (38 cm×38 cm) platen hot press (Wabash MPI, Wabash, Indiana). The mold was heated to 402° F. (206° C.) and hot pressed at pressure of about 1060 psi (73 bar) for 10 minutes to form a rigid 3-dimensional fixed abrasive lap plate blank. The rigid blank plate was mounted on a 12-inch (30.5 cm) square cast iron base plate with the aid double sided adhesive tape. Both sizes of the plate were planarized on a surface grinder to a thickness of 4.0 mm. The planarized rigid blank plate of 4.0 mm thickness was cut into 20.5 mm×9.0 mm rectangles to form grinding plate segments by any known method such as rotary cutters, waterjet cutters, laser cutters, diamond wire cutters, electrical discharge machining (EDM), etc. Waterjet cutting method was used to cut the blank plates to create diamond bead plate segments. The diamond bead plate segments are mounted on the periphery/rim of a 12-inch (30.5 cm) diameter base wheel with the aid of epoxy adhesive to make a segmented grinding cup wheel as shown in in FIG. 2. The mounted segments are planarized to equal height and the segmented cup wheel is balanced before testing. Following Example 1, the diamond bead cup wheel of Example 2 was performance tested on EVG-300 vertical grinder from Engis Corp, Wheeling, IL. The test results are shown in Table 1 below.

### Example 3—Nanoprinting of SiC Wafer Si-Face

The diamond bead cup wheels of Examples 1 and 2 were used in a nanogrinding machining operation and compared with commercially available nanogrinding wheels using the same equipment and tools. The results are shown in Table 1. As seen in Table 1, the fixed-abrasive grinding tools according to the disclosure provide low surface roughness for a combination of various surface roughness parameters, which combination is desirable for a nanogrinding operation. Examples 1 and 2 represent different grinding plate formulations used to form the cup wheels, and each provided a better surface finish than that of the comparative examples. Put another way, even though the comparative examples had superior material removal rates, they were unable to obtain a desirably smooth surface finish useful for a nanogrinding operation.

TABLE 1
Nanogrinding Removal Rates and Surface Roughness Values

| | Material | | | |
|---|---|---|---|---|
| | Removal | Surface | Surface | Surface |
| | Rate | Roughness | Roughness | Roughness |
| Nanogrinding Wheel | [μm/min] | Ra [nm] - AVG | Rt [nm] - AVG | Rv [nm] -AVG |
| Example 1 | 0.48 | 0.84 | 8.8 | −4.23 |
| Example 2 | 0.16 | 0.76 | 10.09 | −6.64 |
| Comparative Example 1 | 1.4 | 2.06 | 43.85 | −28.77 |
| Comparative Example 2 | 1.2 | 1.33 | 52.81 | −38.6 |

### Example 4 to 8—Resin Fixed-Abrasive Grinding Plates with Varying Hardness

Fixed-abrasive grinding plates were formed generally using the procedures above for Examples 1-2, but using different amounts of the various components. The grinding plates were tested for their Rockwell Hardness L Scale values, and the results are shown in Table 2. Table 2 illustrates that the hardness of the grinding plate can be controlled or selected over a wide range of values particularly suitable for a nanogrinding operation.

TABLE 2
Grinding Plate Composition and Hardness Values

| | Example 4 | Example 5 | Example 6 | Example 7 | Example 8 |
|---|---|---|---|---|---|
| Material description | wt % | wt % | wt % | wt % | wt % |
| Porosity Additive (Q-CEL 300 glass | 19 | 19 | 19 | 8.3 | 22 |
| sphere, 90 μm) | | | | | |
| Inorganic Filler (calcium carbonate) | 7.2 | 7.2 | 7.2 | 19 | 6 |
| Chemical Agent (potassium | 2 | 2 | 2 | 2 | |
| permanganate) | | | | | |
| Chemical Agent (manganese | 0.8 | 0.8 | 0.8 | 0.7 | |
| chloride) | | | | | |
| Abrasive Beads (0.5 μm diamond | 43 | 43 | 43 | 43 | 50 |
| abrasive in titanium oxide binder) | | | | | |
| Polymer Resin (benzoxazine resin) | 25.2 | 16.8 | 8.4 | 24.3 | 13 |
| Polymer Resin (EPON SU-8, epoxy | 2.8 | 11.2 | 19.6 | 2.7 | |
| resin) | | | | | |
| Polymer Resin (phenolic resin) | | | | | 9 |
| Total | 100.00 | 100.00 | 100.00 | 100.00 | 100.00 |
| Rockwell Hardness L scale | 108 | 87 | 74 | 113 | 62 |

### Example 9—Formation of Resin Fixed-Abrasive Grinding Segments

Generally, the edges/periphery of a molded part have lower hardness than the interior portion of the part. Thus, by forming a large blank plate (e.g., a fixed abrasive grinding plate as described herein), smaller segments can be cut from the interior portion of the blank plate to provide grinding plate segments with more consistent hardness values to be used as a plurality of grinding elements in a corresponding grinding tool.

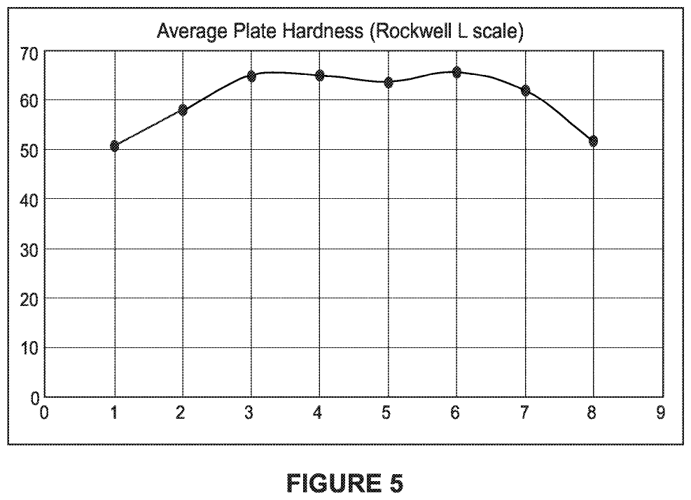

For example, a large 7.5″×7.5″×0.17″ (19.1 cm×19.1 cm×0.43 cm) blank plate 100 corresponding to Example 8 above was formed as illustrate in FIG. 4. The blank plate was tested for hardness at a series of different sampling locations 1, 2, 3, . . . 8 indicated by the “X” symbols in FIG. 4. The average Rockwell Hardness L values at the different sampling locations is shown in FIG. 5, where it is seen that the hardness is relatively consistent at sampling locations 2-7 (i.e., the interior of the blank plate 100), and it is substantially lower at sampling locations 1 and 8 (i.e., the edge or periphery of the blank plate 100). Accordingly, interior segments 220 at locations 2-7 were cut from the blank plate 100 and used to form the corresponding cup wheel of Example 8. The outer portion of the blank plate 100 (i.e., corresponding to a periphery of about 1 cm-2.5 cm) was not used to form grinding segments.

### Example 10—Nanogrinding of SiC Wafer with Vitrified Fixed-Abrasive Grinding Plate

A vitrified bond diamond abrasive plate blank was prepared by thoroughly mixing all the powder components of: 94 g of graded diamond beads of 500 nm monocrystalline diamond (from Engis Corp. Wheeling, IL), 36.8 g of glass frits 90741 powder (Ferro, Cleveland, Ohio), 9.6 g Feldspar (from Laguna Clay, Byesville, Ohio) and 19.2 g of Q-Cel 300 glass hollow spheres (from Potters Industries LLC, Valley Forge, Pennsylvania). The graded diamond beads were prepared as described above in Preparation Example 1 (silicon dioxide inorganic metal oxide binder), but with a 500 nm diamond size. The glass frit powder had a particle size generally ranging between 30-800 microns (e.g., as a breadth of the size distribution), and the following composition (w/w) of oxide materials: boron trioxide 5-20%, alumina 5-20%, sodium oxide 5-20%, potassium oxide <5%, lithium oxide <5%, calcium oxide <5%, magnesium oxide <5%, zirconium dioxide <5%, titanium dioxide <5%, bismuth trioxide <5%, and silica >20% (balance). The powder components were thoroughly mixed in a rotary mixer, then 32 g of 10% gum Arabic solution in water was added and continued blending until homogenous. The gum Arabic is the glue or binder to hold the powder mixture together into a “green body”. The mixture was poured into 7.5-inch (19 cm) square mold and leveled, the flange was replaced to make a tight fit. The mold and content were put onto a 30 ton Wabash 15″×15″ (38 cm×38 cm) platen hot press (Wabash MPI, Wabash, Indiana). The mold was cold pressed at pressure of about 500 psi for 1 minute to form a “green body” plate blank. The “green body” blank plate was allowed to air dry for about 24 hours before firing in the furnace. After drying, the green body plate was fired at 1170° F. for 1 hour in a Skutt Automatic kiln, model GM-1018 (from Skutt Ceramic Products, Portland, Oregon) to make a vitrified fixed-abrasive blank plate. The firing process also decomposes and vaporizes/removes the gum or other binder material from final blank plate. Cut the vitrified abrasive plate by waterjet method into 20.5 mm×9.0 mm rectangles to form grinding plate segments. The vitrified diamond plate segments are mounted on the periphery/rim of a 12-inch (30.5 cm) diameter base wheel with the aid of epoxy adhesive to make a segmented grinding cup wheel as shown in FIG. 2. The mounted segments are planarized to equal height and the segmented cup wheel is balanced before testing.

The segmented vitrified bond cup wheel is fixed to EVG300 vertical grinder (from Engis Corp., Wheeling, IL) equipped with ceramic vacuum chuck rotary table. The segmented grinding wheel is positioned a wheel radius off from the rotational axis of the rotary table. The sample workpiece is silicon face of 6″ (15.2 cm) SiC wafer 4H-SiC. The work piece is secured at the center of the ceramic vacuum chuck at a pressure less than −0.8 atmospheres (−0.81 bar). During a nano-grinding operation, both the cup wheel and the rotary table rotates in the same direction. The grinding cup wheel rotates at speed of 1325/1532 RPM counterclockwise, while the vacuum chuck rotary table rotates at 103 RPM in the same direction of the cup wheel. Initial feed rate of the cup wheel is 0.3 μm/min as it encounters the work piece and it is reduced in the final 10% set wheel z-position (μm), to 0.05 μm/min to ensure better surface finish and planarization. The cup wheels are additionally dressed using a 220 mesh silicon carbide fine pad. Deionized water with flow rate of 8-9 L/min is used as a coolant. The difference in measured wafer thickness before and after processing is used to indicate the sample material removal rate. The wheel wear rate is calculated based on the changes in height of the wheel segments before and after processing and is measured using the Mituyo drop gauge indicator. The ratio of the volume of material removed and the volume of wheel wear determines the grinding ratio. The performance of the vitrified abrasive cup wheel is determined by the amount of material removed, surface finish of the SiC work piece as measured by surface roughness (Ra) and the force consumption. Surface roughness is measured using Zygo NEWVIEW 6k Optical Profilometer. Table 3 shows the performance characteristics of the vitrified fixed-abrasive grinding plate. The material removal in Table 3 reflects the total amount/thickness of material removed over the entire grinding process. The wheel % load in Table 3 is relative to the grinder's maximum electrical current limit (amps) for rotation of the wheel spindle, which maximum value is specific to a given grinder model.

TABLE 3
Grinding Performance of Vitrified Fixed-Abrasive Cup Wheel

| | Material | Surface | |
|---|---|---|---|
| | Removal | Roughness, Ra | Maximum Wheel |
| Trial # | (μm) | (nm) | % Load |
| 1 | 5 | 3.2 | 10 |
| 2 | 13 | 2.8 | 17 |
| 3 | 12 | 2.6 | 16 |
| 4 | 11 | 2.18 | 13 |

As illustrated in Table 3, the material removal is high and consistent from trial 2 to 4, indicating self-dressing ability of the vitreous fixed-abrasive grinding wheel. The reduction in the initial material removal for Trial 1 is due to high incoming TTV (Total Thickness Variation). The wheel loading (force consumption) is a critical component in the performance of the grinding wheel. In grinding wheel operations, wheel load indicates the torque resistance of the spindle. The percent is noted as the amperage of the grind spindle. Typically, a maximum wheel % load is desirably less than 40%. A high % wheel load causes burnishing of the work piece or bowing and warping of the wafer. The low maximum wheel load of the vitreous fixed-abrasive grinding wheel makes it possible to grind wafers with consistent low TTV.

Because other modifications and changes varied to fit particular operating requirements and environments will be apparent to those skilled in the art, the disclosure is not considered limited to the example chosen for purposes of illustration, and covers all changes and modifications which do not constitute departures from the true spirit and scope of this disclosure.

Accordingly, the foregoing description is given for clearness of understanding only, and no unnecessary limitations should be understood therefrom, as modifications within the scope of the disclosure may be apparent to those having ordinary skill in the art.

All patents, patent applications, government publications, government regulations, and literature references cited in this specification are hereby incorporated herein by reference in their entirety. In case of conflict, the present description, including definitions, will control.

Throughout the specification, where the compositions, processes, kits, or apparatus are described as including components, steps, or materials, it is contemplated that the compositions, processes, or apparatus can also comprise, consist essentially of, or consist of, any combination of the recited components or materials, unless described otherwise. Component concentrations can be expressed in terms of weight concentrations, unless specifically indicated otherwise. Combinations of components are contemplated to include homogeneous and/or heterogeneous mixtures, as would be understood by a person of ordinary skill in the art in view of the foregoing disclosure.

1. A fixed-abrasive grinding plate comprising:
a) a plurality of micron-sized composite abrasive beads in an amount of 30 wt. % to 95 wt. % on a dry weight basis of the grinding plate;
b) at least one porosity additive in an amount of 1 wt. % to 40 wt. % on a dry weight basis of the grinding plate;
c) one or more inorganic fillers in an amount of 1 wt. % to 40 wt. % on a dry weight basis of the grinding plate; and
d) at least one polymeric resin in an amount of 3 wt. % to 40 wt. % on a dry weight basis of the grinding plate, wherein the polymeric resin bonds the abrasive beads;
wherein:
the grinding plate has a hardness value in a range of 20 to 120 on the Rockwell Hardness L scale, and
the grinding plate has a calculated density in a range 0.8 g/cm³ to 1.8 g/cm³.

2. A fixed-abrasive grinding plate comprising:
a) a plurality of micron-sized composite abrasive beads in an amount of 30 wt. % to 95 wt. % on a dry weight basis of the grinding plate;
b) at least one porosity additive in an amount of 1 wt. % to 40 wt. % on a dry weight basis of the grinding plate;
c) one or more flux agents in an amount of 1 wt. % to 40 wt. % on a dry weight basis of the grinding plate; and
d) a vitreous matrix in an amount of 3 wt. % to 40 wt. % on a dry weight basis of the grinding plate, wherein the vitreous matrix bonds the abrasive beads.

3. The fixed-abrasive grinding plate of claim 2, wherein:
the abrasive beads have an average particle size in a range of 5 μm to 50 μm;
each abrasive bead comprises (i) a plurality of abrasive particles having an average particle size in a range of 10 nm to 10 μm, and (ii) an inorganic metal oxide binder;
the abrasive particles are selected from the group consisting of natural diamond, synthetic diamond, cubic boron nitride, silicon carbide, and combinations thereof;
the inorganic metal oxide binder is selected from the group consisting of silicon dioxide, titanium dioxide, cerium oxide, zirconium oxide, aluminum oxide, and mixtures thereof; and
the abrasive particles are present in an amount of 20 wt. % to 90 wt. % of the abrasive beads.

4. (canceled)

5. (canceled)

6. (canceled)

7. The fixed-abrasive grinding plate of claim 2, wherein:
a weight ratio of (i) the vitreous matrix to (ii) the porosity additive in the grinding plate is in a range of 1 to 4;
a combined amount of the vitreous matrix and the porosity additive in the grinding plate is at least 30 wt. % on a dry weight basis of the grinding plate;
a weight ratio of (i) the vitreous matrix to (ii) a combined amount of the porosity additive and the flux agent in the grinding plate is in a range of 0.8 to 1.5; and
a combined amount of the vitreous matrix, the porosity additive, and the flux agent in the grinding plate is at least 40 wt. % on a dry weight basis of the grinding plate.

8. (canceled)

9. The fixed-abrasive grinding plate of claim 2, wherein:
the grinding plate has a surface area porosity of 5% to 60%;
a plurality of the pores in the grinding plate is neither uniform nor regular and are not intra-connected throughout a thickness of the grinding plate; and
the porosity additive comprises hollow glass spheres having an average diameter in a range of 10 μm to 200 um.

10. (canceled)

11. The fixed-abrasive grinding plate of claim 2, wherein:
the vitreous matrix comprises silica (SiO₂) and one or more of lithium oxide (Li₂O), sodium oxide (Na₂O), potassium oxide (K₂O), boron trioxide (B₂O₃), aluminum oxide (Al₂O₃), calcium oxide (CaO), magnesium oxide (MgO), barium oxide (BaO), zirconium oxide (ZrO), zirconium dioxide (ZrO₂), titanium dioxide (TiO₂), zinc oxide (ZnO), calcium difluoride (CaF₂), manganese dioxide (MnO₂), and bismuth trioxide (Bi₂O₃);
silica is present in the vitreous matrix in an amount of at least 20 wt. %;
one or more of sodium oxide, potassium oxide, aluminum oxide, calcium oxide, and barium oxide are individually present in the vitreous matrix in an amount in a range of 3 wt. % to 30 wt. %;
optionally, boron trioxide is present in the vitreous matrix in an amount of at least 3 wt. %; and
the flux agent is selected from the group consisting of clay, kaolin, feldspar, borax, talc, wollastonite, nitrates of lithium, sodium, and potassium, carbonates of lithium, sodium, and potassium, and combinations thereof.

12. (canceled)

13. The fixed-abrasive grinding plate of claim 2, wherein:
the vitreous matrix has a linear coefficient of thermal expansion in a range of 20×10⁻⁷/K to 200×10⁻⁷/K;
the vitreous matrix has a transformation temperature in a range of 400° C. to 800° C.;
the vitreous matrix has a softening temperature in a range of 500° C. to 1000° C.; and
the grinding plate has a calculated density in a range of 0.7 q/cm³ to 1.3 q/cm³.

14. (canceled)

15. (canceled)

16. (canceled)

17. (canceled)

18. (canceled)

19. A fixed-abrasive grinding tool comprising:
a base plate; and
a plurality of fixed-abrasive grinding segments mounted to the base plate, wherein the fixed-abrasive grinding segments comprise the fixed-abrasive grinding plate according to claim 1, or a portion thereof.

20. (canceled)

21. A fixed-abrasive grinding tool comprising:
a base plate; and
a plurality of fixed-abrasive grinding segments mounted to the base plate, wherein the fixed-abrasive grinding segments comprise the fixed-abrasive grinding plate according to claim 2.

22. The fixed-abrasive grinding tool of claim 21, wherein the fixed-abrasive grinding tool is in the form of a grinding wheel.

23. The fixed-abrasive grinding tool of claim 21, wherein the fixed-abrasive grinding tool is in the form of a cup wheel.

24. A fixed-abrasive grinding kit comprising:
a plurality of fixed-abrasive grinding tools comprising:
(i) at least one polymeric fixed-abrasive grinding tool comprising a first base plate, and a plurality of first fixed-abrasive grinding segments mounted to the first base plate, the first fixed-abrasive grinding segments comprising a) a plurality of micron-sized composite abrasive beads in an amount of 30 wt. % to 95 wt. % on a dry weight basis of the grinding segments, b) at least one porosity additive in an amount of 1 wt. % to 40 wt. % on a dry weight basis of the grinding segments, c) one or more inorganic fillers in an amount of 1 wt. % to 40 wt. % on a dry weight basis of the grinding plate, and d) at least one polymeric resin in an amount of 3 wt. % to 40 wt. % on a dry weight basis of the grinding segments, wherein the polymeric resin bonds the abrasive beads, wherein the grinding segments have a hardness value in a range of 20 to 120 on the Rockwell Hardness L scale, and the grinding segments have a calculated density in a range 0.8 q/cm³ to 1.8 q/cm³; and
(ii) at least one vitreous fixed-abrasive grinding tool comprising a second base plate, and a plurality of second fixed-abrasive grinding segments mounted to the second base plate, the second fixed-abrasive grinding segments comprising a) a plurality of micron-sized composite abrasive beads in an amount of 30 wt. % to 95 wt. % on a dry weight basis of the grinding segments, b) at least one porosity additive in an amount of 1 wt. % to 40 wt. % on a dry weight basis of the grinding segments, c) one or more flux agents in an amount of 1 wt. % to 40 wt. % on a dry weight basis of the grinding segments, and d) a vitreous matrix in an amount of 3 wt. % to 40 wt. % on a dry weight basis of the grinding segments, wherein the vitreous matrix bonds the abrasive beads.

25. A method for machining a substrate, the method comprising:
performing at least one of grinding and polishing with the fixed-abrasive grinding tool according to claim 19 on a substrate.

26. A method for machining a substrate, the method comprising:
performing at least one of grinding and polishing with the fixed-abrasive grinding tool according to claim 21 on a substrate.

27. A method for machining a substrate, the method comprising:
performing at least one of grinding and polishing with the fixed-abrasive grinding tool according to claim 19 on a substrate;
the substrate has an initial surface roughness Ra of at least 30 nm prior to performing the at least one of grinding and polishing;
the substrate has a final surface roughness Ra of not more than 1 nm subsequent to performing the at least one of grinding and polishing; and
an average material removal rate from the substrate is not more than 1 μm/min while performing the at least one of grinding and polishing.

28. A method for machining a substrate, the method comprising:
performing at least one of grinding and polishing with the fixed-abrasive grinding tool according to claim 21 on a substrate;
the substrate has an initial surface roughness Ra of at least 200 nm prior to performing the at least one of grinding and polishing;
the substrate has a final surface roughness Ra of not more than 5 nm subsequent to performing the at least one of grinding and polishing;
an average material removal rate from the substrate is in a range of 2 μm/min to m/min while performing the at least one of grinding and polishing.

29. A method for machining a substrate using the fixed-abrasive grinding kit of claim 24, the method comprising:
performing at least one of grinding and polishing on the substrate with the vitreous fixed-abrasive grinding tool; and
subsequently performing at least one of grinding and polishing on the substrate with the polymeric fixed-abrasive grinding tool.

30. The method of claim 26, comprising performing nano-grinding as a grinding operation on the substrate;
wherein the substrate is selected from the group consisting of sapphire, titanium carbide reinforced alumina (AlTiC), silicon carbide (SiC), gallium nitride (GaN), aluminum nitride (AlN), zinc selenide (ZnSe), silicon wafers, ceramic substrates, optical substrates, and combinations thereof.

31. A method for forming fixed-abrasive grinding segments, the method comprising:
performing at least one of hot-pressing, heat-assisted hardening, and room-temperature hardening of a mixture to form a blank plate, the mixture comprising:
a) a plurality of micron-sized composite abrasive beads in an amount of 30 wt. % to 95 wt. % relative to the mixture,
b) at least one porosity additive in an amount of 1 wt. % to 40 wt. % relative to the mixture,
c) one or more inorganic fillers in an amount of 1 wt. % to 40 wt. % relative to the mixture; and
d) at least one uncured polymeric resin in an amount of 3 wt. % to 40 wt. % relative to the mixture; and
cutting the blank plate to form a plurality of fixed-abrasive grinding segments each comprising the fixed-abrasive grinding plate according to claim 1.

32. A method for forming fixed-abrasive grinding segments, the method comprising:
performing firing of a mixture to form a blank plate, the mixture comprising:
a) a plurality of micron-sized composite abrasive beads in an amount of 30 wt. % to 95 wt. % relative to the mixture,
b) at least one porosity additive in an amount of 1 wt. % to 40 wt. % relative to the mixture,
c) one or more flux agents in an amount of 1 wt. % to 40 wt. % relative to the mixture;
d) a plurality of glass frits in an amount of 3 wt. % to 40 wt. % relative to the mixture;
e) optionally a binder in an amount up to 5 wt. % relative to the mixture; and
cutting the blank plate to form a plurality of fixed-abrasive grinding segments each comprising the fixed-abrasive grinding plate according to claim 2.

33. The method of claim 32, wherein:
the plurality of fixed-abrasive grinding segments are cut from an interior portion of the blank plate;
the interior portion corresponds to an interior surface area in a range of 50% to 80% relative to a surface area of a face of the blank plate;
the method further comprises bonding the plurality of fixed-abrasive grinding segments to a base plate, and planarizing the plurality of fixed-abrasive grinding segments to a flattened state.

34. (canceled)

35. (canceled)

36. (canceled)

37. The method of claim 32, wherein:
the method comprises:
cold-pressing the mixture in a mold at a temperature in a range of 50° F. to 200° F. and at a pressure of 300 psi to 1000 psi to form a green part,
optionally drying the green part to remove water present in the mixture,
firing the green part at a temperature in a range of 1000° F. to 1400° F.;
the blank plate has a thickness in a range of 0.1 inch to 1 inch; and
the blank plate has lateral dimensions in a range of 1 inch to 20 inch.
